(19) United States
(12) Patent Application Publication
(10) Pub. No.: US 2026/0205192 A1
(43) Pub. Date: Jul. 16, 2026

(54) Satellite Assistance Information

(71) Applicant: Telefonaktiebolaget LM Ericsson (publ), Stockholm (SE)

(72) Inventors: Helka-Liina Määttänen, Espoo (FI); Ignacio Javier Pascual Pelayo, Stockholm (SE); Emre Yavuz, Stockholm (SE)

(21) Appl. No.: 19/135,425

(22) PCT Filed: Dec. 5, 2023
(86) PCT No.: PCT/EP2023/084364

§ 371 Date: Jun. 4, 2025

Related U.S. Application Data
(60) Provisional application No. 63/386,164, filed on Dec. 5, 2022.

(51) Int. Cl. H04B 7/185; H04W 24/08

(52) U.S. Cl. CPC H04B 7/18513; H04W 24/08

(57) ABSTRACT

A communication device (16) receives an indication (25) that a satellite (12) or satellite assistance information (24-1) for a first cell or frequency (18-1) is the same as that (12, 24-2) for a second cell or frequency (18-2), e.g., where the second cell or frequency (18-2) may be a serving cell or a carrier frequency of the serving cell. Based on the indication (25), the communication device (16) in some embodiments performs a measurement on the first cell or frequency (18-1) using satellite assistance information (24-2) received for the second cell or frequency (18-2).

### TECHNICAL FIELD

The present application relates generally to a communication network, and relates more particularly to satellite assistance information in such a network.

### BACKGROUND

A non-terrestrial network (NTN) can provide communication service over a wider area of Earth than a terrestrial network, e.g., so that service is more independent of location. To provide this coverage, the non-terrestrial network may for example include a satellite that provides service using a number of cells or frequencies. A cell provided by a satellite may correspond to the footprint of a beam or spotbeam, e.g., which may move over the earth surface with the satellite movement or may be earth fixed with some beam pointing mechanism used by the satellite to compensate for its motion.

An NTN assists communication devices to access the NTN via a satellite by providing communication devices with so-called satellite assistance information. Satellite assistance information may include for example satellite ephemeris information, timing advance information, and/or other parameters usable to determine the orbit, position, and/or velocity of a satellite. Problematically, though, satellite assistance information can be quite large, meaning that transmitting the satellite assistance information proves inefficient in terms of resource consumption and jeopardizes system performance and/or capacity.

### SUMMARY

Some embodiments herein avoid or minimize duplicative transmission of satellite assistance information to a communication device. Some embodiments thereby advantageously improve satellite assistance information transmission efficiency and correspondingly realize improvements to system performance and/or capacity. To this end, some embodiments herein indicate to a communication device that a first cell or frequency (e.g., a neighbor cell or frequency) is associated with the same satellite or satellite assistance information as that with which a second cell or frequency is associated (e.g., a serving cell or frequency). In this case, rather than transmitting satellite assistance information twice, once for the first cell or frequency and again for the second cell or frequency, the communication network can more efficiently transmit the satellite assistance information just once and indicate that the satellite assistance information is the same for both the first cell or frequency and the second cell or frequency. Alternatively or additionally, a communication device herein may assume that a first cell or frequency is associated with the same satellite or satellite assistance information as that with which a second cell or frequency is associated, e.g., if the communication device does not explicitly receive satellite assistance information for the first cell or frequency.

More particularly, embodiments herein include a method performed by a communication device. The method comprises receiving an indication that a satellite or satellite assistance information for a first cell or frequency is the same as that for a second cell or frequency.

Other embodiments herein include a method performed by a network node configured for use in a communication network. The method comprises transmitting, to a communication device, an indication that a satellite or satellite assistance information for a first cell or frequency is the same as that for a second cell or frequency.

Embodiments herein also include corresponding apparatus, computer programs, and carriers of those computer programs.

### BRIEF DESCRIPTION OF THE DRAWINGS

FIG. 1 illustrates a communication network in the form of a non-terrestrial network (NTN) in accordance with some embodiments.

FIG. 2 shows an example architecture of a satellite network with bent pipe transponders in accordance with some embodiments.

FIG. 3 illustrates a set of parameters for a satellite orbit in accordance with some embodiments.

FIG. 4 is a logic flow diagram of a method performed by a communication device configured for use in a communication network in accordance with some embodiments.

FIG. 5 is a logic flow diagram of a method performed by a communication device configured for use in a communication network in accordance with other particular embodiments.

FIG. 6 is a logic flow diagram of a method performed by a communication device in accordance with other particular embodiments.

FIG. 7 is a logic flow diagram of a method performed by a network node configured for use in a communication network in accordance with other particular embodiments.

FIG. 8 is a logic flow diagram of a method performed by a network node configured for use in a communication network in accordance with other particular embodiments.

FIG. 9 is a block diagram of a communication device in accordance with particular embodiments.

FIG. 10 is a block diagram of a network node in accordance with particular embodiments.

FIG. 11 shows an example of a communication system in accordance with some embodiments.

FIG. 12 is a block diagram of a host which may be an embodiment of the host of FIG. 11, in accordance with various aspects described herein.

FIG. 13 shows a communication diagram of a host communicating via a network node with a UE over a partially wireless connection in accordance with some embodiments.

### DETAILED DESCRIPTION

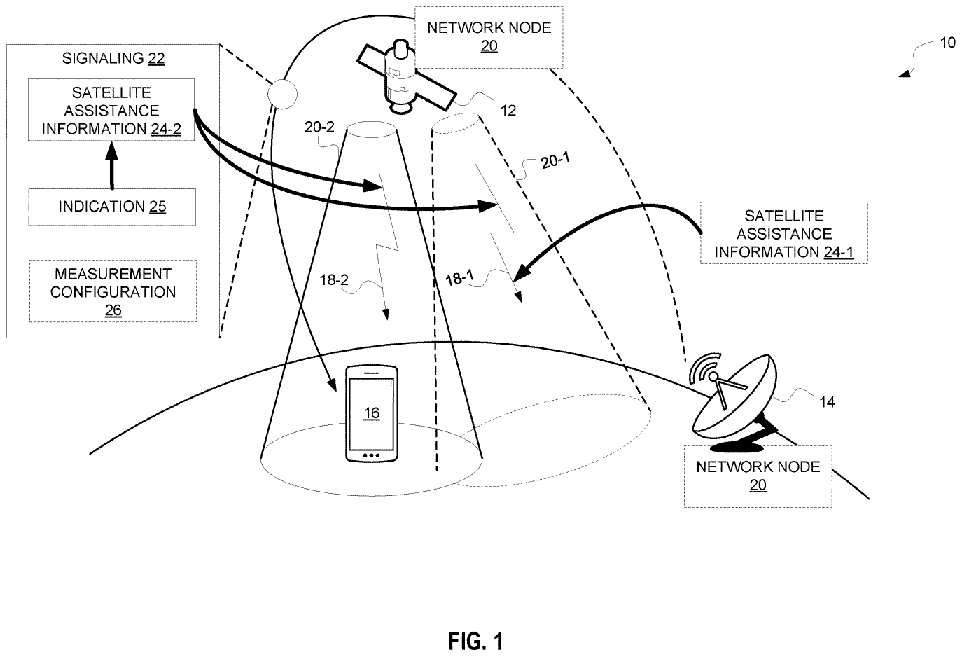

FIG. 1 shows a communication network 10 in the form of a non-terrestrial network (NTN). The communication network 10 as shown includes a satellite 12 (e.g., a communications satellite) and an earth-based gateway 14 that connects the satellite 12 to a base station or a core network. The satellite 12, potentially in cooperation with the earth-based gateway 14, provides a cell or frequency 18-2, e.g., a serving cell or frequency of the communication device 16. This cell or frequency 18-2 may for example correspond to a beam 20-2 (or spot beam). The satellite 12 may for example be equipped with a phased array antenna, an electronically steerable parabolic antenna, or the like, in order to form the beam 20-2 in a spatial dimension. In these and other embodiments, the beam 20-2 may serve or otherwise be associated with the cell or frequency 18-2, e.g., as identified by a physical cell identity in the case that cell or frequency 18-2 is a cell.

To assist the communication device 16 with accessing the cell or frequency 18-2 provided by the satellite 12, a network node 20 transmits signaling 22 to the communication device 16. The signaling 22 includes satellite assistance information 24-2 associated with the cell or frequency 18-2. The network node 20 may for instance be or be associated with (e.g., co-located with) the earth-based gateway 14 or the satellite 12. Either way, the satellite assistance information 24-2 associated with the cell or frequency 18-2 may include one or more parameters for the communication device 16 to access the cell or frequency 18-2 via the satellite 12. For example, the satellite assistance information 24-2 may include satellite ephemeris information, epoch timing information, modified scheduling information, and/or timing advance information to assist the communication device 16 to access the cell or frequency 18-2 via the satellite 12. In these and other embodiments, as detailed further below, the satellite assistance information 24-2 associated with the cell or frequency 18-2 (e.g., serving cell or frequency) may fully or partly correspond to, or be included in, an ntn-Config-r17 information element (IE) within System Information Block #19 (SIB19).

In this context, though, the communication device 16 may also need satellite assistance information 24-1 associated with another cell or frequency 18-1. This other cell or frequency 18-1 will be referred to as a first cell or frequency 18-1, whereas cell or frequency 18-2 will be referred to as a second cell or frequency 18-2. In some embodiments, as an example, the first cell or frequency 18-1 is a neighbor cell or frequency that neighbors the second cell or frequency 18-2 from a geographical or mobility perspective. Regardless, in one embodiment, the communication device 16 may need the satellite assistance information 24-1 associated with the first cell or frequency 18-1 in order to perform a measurement on the first cell or frequency 18-1, e.g., for mobility purposes. In this case, the communication network 10 may transmit a measurement configuration 26 to the communication device 16 which indicates that the first cell or frequency 18-1 is an object on which the communication device 16 is to perform a measurement, i.e., that the first cell or frequency 18-1 is a measurement object (MO). The measurement configuration 26 may for example include a MO information element (IE) with a list of one or more identifiers identifying one or more cells or frequencies on which the communication device 16 is to perform a measurement, including the first cell or frequency 18-1.

Notably, some embodiments herein exploit the scenario shown in FIG. 1, where the same satellite 12 provides both the first cell or frequency 18-1 and the second cell or frequency 18-2, as an opportunity to avoid having to transmit the satellite assistance information 24-1 associated with first cell or frequency 18-1. Indeed, where the same satellite 12 provides both the first cell or frequency 18-1 and the second cell or frequency 18-2, the satellite assistance information 24-1 associated with first cell or frequency 18-1 is the same as the satellite assistance information 24-2 associated with second cell or frequency 18-2.

As shown in FIG. 1, then, the network node 20 transmits an indication 25 to the communication device 16. In some embodiments, the indication 25 is an indication that the first cell or frequency 18-1 is associated with the same satellite or satellite assistance information as that with which the second cell or frequency 18-2 is associated, i.e., that the satellite assistance information 24-1 for the first cell or frequency 18-1 is the same as the satellite assistance information 24-2 for the second cell or frequency 18-2. Stated another way, the indication 25 may be framed as being an indication 25 that the satellite or satellite assistance information 24-1 for the first cell or frequency 18-1 is the same as that 24-2 for the second cell or frequency 18-2. The indication 25 may for example indicate that the satellite for the first cell or frequency 18-1 is the same as that for the second cell or frequency 18-2, by indicating that the same satellite provides both the first cell or frequency 18-1 and the second cell or frequency 18-2. Either way, rather than transmitting the same satellite assistance information 24-1, 24-2 twice, once for the first cell or frequency 18-1 and again for the second cell or frequency 18-2, the network node 20 more efficiently transmits the satellite assistance information 24-1, 24-2 just once and transmits the indication 25 that the satellite assistance information 24-1, 24-2 is the same for both the first cell or frequency 18-1 and the second cell or frequency 18-2. Alternatively or additionally, the communication device 16 may assume that the first cell or frequency 18-1 is associated with the same satellite 12 or satellite assistance information 24-1, 24-2 as that with which the second cell or frequency 18-2 is associated, e.g., if the communication device 16 receives the indication 25 and/or if the communication device 16 does not explicitly receive satellite assistance information 24-1 for the first cell or frequency 18-1. These and other embodiments thereby avoid or minimize duplicative transmission of satellite assistance information 24-1, 24-2 to the communication device 16. Some embodiments thereby advantageously improve satellite assistance information transmission efficiency and correspondingly realize improvements to system performance and/or capacity.

Consider for example embodiments where the communication device 16 is to perform a measurement on the first cell or frequency 18-1, e.g., a neighbor cell or frequency. The communication device 16 may receive satellite assistance information 24-2 for the second cell or frequency 18-2, e.g., the serving cell or frequency. And, rather than redundantly receiving satellite assistance information 24-1 for the first cell or frequency 18-1, the communication device 16 simply receives the indication 25. Based on this indication 25, then, the communication device 16 performs the measurement on the first cell or frequency 18-1 using the satellite assistance information 24-2 received for the second cell or frequency 18-2.

The indication 25 herein may be realized in any number of possible ways. In one implementation, the indication 25 is included in the measurement configuration 26 that specifies the measurement is to be performed by the communication device 16 on the first cell or frequency 18-1. That is, the indication 25 in FIG. 1 may be included in the measurement configuration 26 shown in FIG. 1. In these and other embodiments, the indication 25 may be explicit.

In another implementation, more generally, the communication device 16 may receive a list of one or more identifiers identifying one or more cells or frequencies, including the first cell or frequency 18-1, that are each associated with the same satellite or satellite assistance information as that with which the second cell or frequency 18-2 is associated. The indication 25 in this case may be the identifier of the first cell or frequency 18-1 being included in the list.

In yet another implementation, the indication 25 is a flag associated with an identifier of the first cell or frequency 18-1 indicating that the satellite or satellite assistance information associated with the first cell or frequency 18-1 is the same as that with which the second cell or frequency 18-2 is associated.

In a further implementation where the second cell or frequency 18-2 is a serving cell or frequency and the first cell or frequency 18-1 is a neighbor cell or frequency, the communication device 16 may receive a message that includes satellite assistance information for the serving cell or frequency 18-2 and that further includes satellite assistance information for each of one or more neighbor cells or frequencies, including the first cell or frequency 18-1. In this case, the indication 25 in some embodiments is a pointer associated with the first cell or frequency 18-1 pointing to satellite assistance information 24-1 in the message that is associated with the first cell or frequency 18-1. That is, rather than the message explicitly including satellite assistance information 24-1 for the first cell or frequency 18-1, the message points to satellite assistance information included in the message for another cell or frequency, e.g., points to satellite assistance information 24-2 included in the message for the serving cell or frequency.

Other possible implementations by contrast realize the indication 25 implicitly, e.g., as the absence of information in signaling. In one such implementation, the communication device 16 receives signaling that explicitly includes satellite assistance information for one or more cells or frequencies, including the second cell or frequency 18-2. Here, the indication 25 may be that the signaling does not explicitly include satellite assistance information 24-1 for the first cell or frequency 18-1. That is, the fact that the signaling does not explicitly include satellite assistance information 24-1 for the first cell or frequency 18-1 indicates to the communication device 16 that satellite assistance information 24-1 for the first cell or frequency 18-1 is the same as the satellite assistance information explicitly included in the signaling for another cell or frequency, e.g., the second cell or frequency 18-2.

Consider another implementation in a context where the second cell or frequency 18-2 is a serving cell of the communication device 16 or a carrier frequency of the serving cell. In this case, the communication device 16 may receive a list of identifier(s) identifying cell(s) or frequenc(ies) on which the communication device 16 is to perform a measurement, where the list includes a first identifier identifying the first cell or frequency 18-1. The communication device 16 may also receive, for each of one or more neighbor identifiers that respectively identify one or more neighbor cells or frequencies, satellite assistance information associated with that neighbor cell or frequency. That is, the communication device 16 receives signaling that explicitly includes the satellite assistance information for each of one or more of the neighbor cells or frequencies. The indication 25 in this case may be that the first identifier does not match any neighbor identifier for which the communication device 16 has received satellite assistance information. In this case, then, the fact that the communication device 16 does not receive satellite assistance information 24-1 associated with the first cell or frequency 18-1 indicates to the communication device 16 that the satellite assistance information 24-1 is the same as that for the serving cell or carrier frequency.

In a similar example where the first cell or frequency 18-1 is a neighbor cell or frequency and the second cell or frequency 18-2 is a serving cell or frequency, the communication device 16 may receive a neighbor cell configuration information element for the neighbor cell or frequency. The neighbor cell configuration information element includes a neighbor identifier identifying the neighbor cell or frequency but excludes satellite assistance information for the neighbor cell or frequency. In this case, then, the indication 25 is that the neighbor cell configuration information element excludes satellite assistance information for the neighbor cell or frequency. As such, the indication 25 indicates that the satellite or satellite assistance information associated with the neighbor cell or frequency is the same as that associated with the serving cell or frequency.

Note that although some embodiments are exemplified with a scenario where the second cell or frequency 18-2 is a serving cell or frequency and the first cell or frequency 18-1 is a neighbor cell or frequency, embodiments herein are extendable to any two cells or frequencies, e.g., for indicating that a first cell or frequency is associated with the same satellite or satellite assistance information as that associated with a second cell or frequency. As one different example, the cells or frequencies may be two neighbor cells or frequencies, e.g., such that the indication 25 indicates that a first neighbor cell or frequency is associated with the same satellite or satellite assistance information as that associated with a second neighbor cell or frequency. Generally, then, some embodiments herein transmit satellite assistance information for one cell or frequency and transmit just an indication for another cell or frequency in lieu of duplicative satellite assistance information.

Note, too, that the indication 25 may effectively inform the communication device 16 about the relationship of transmitted satellite assistance information to cells or frequencies, by conversely indicating that satellite assistance information associated with a cell or frequency is not the same as that associated with another cell or frequency.

Note further that, in some embodiments, the satellite assistance information that the indication 25 indicates as being the same for the cells or frequencies 18S, 18N is only a portion of the satellite assistance information provided for one of the cells or frequencies. In this case, there may be some common satellite assistance information that is common to both cells or frequencies 18S, 18N, but there may also be some cell- or frequency-specific satellite assistance information that is specific to each of the cells or frequencies 18S, 18N.

Consider additional details of some embodiments which may be realized in the context of 3GPP standardized operation of a Non-Terrestrial Network (NTN), e.g., where the communication device 16 may be exemplified as a user equipment (UE). In some embodiments, the communication network 10 shown in FIG. 1 is a satellite radio access network. The network 10 in this case includes the satellite 12 or other space-borne platform, as well as the earth-based gateway 14. This gateway 14 connects the satellite 12 to a base station or a core network, depending on the choice of architecture. The network 10 may also include a feeder link (not shown) that refers to the link between the gateway 14 and the satellite 12. The network 10 may further include a service link (not shown) that refers to the link between the satellite 12 and the wireless device 18 (e.g., a user equipment, UE).

In some embodiments, the communication network 10 has a Bent pipe transponder architecture. In this case, the base station is located on Earth behind the gateway 14, and the satellite 12 operates as a repeater forwarding the feeder link signal to the service link, and vice versa. In other embodiments, the communication network 10 has a Regenerative transponder architecture. In this case, the satellite 12 is in the base station and the service link connects it to the earth-based core network. Accordingly, in some embodiments where the network node 20 in FIG. 1 is implemented as a base station, the network node 20 may be either located on Earth behind the gateway 14 (if the network 10 has the Bent pipe transponder architecture) or located at the satellite 12 (if the network 10 has the Regenerative transponder architecture).

Depending on the orbit altitude, the satellite 12 may be categorized as a low earth orbit (LEO), medium earth orbit (MEO), or geostationary earth orbit (GEO) satellite. LEO has typical heights ranging from 250-1,500 km, with orbital periods ranging from 90-120 minutes. MEO has typical heights ranging from 5,000-25,000 km, with orbital periods ranging from 3-15 hours. And GEO has a height at about 35,786 km, with an orbital period of 24 hours.

In some embodiments, the satellite 12 generates multiple (e.g., several) beams over a given area. The footprint of any given beam may be in an elliptic shape, which may be considered as a cell. The footprint of a beam may be referred to as a spotbeam. The spotbeam may move over the earth surface with the satellite movement or may be earth fixed with some beam pointing mechanism used by the satellite 12 to compensate for its motion. The size of the spotbeam may depend on the system design, which may range from tens of kilometers to a few thousands of kilometers.

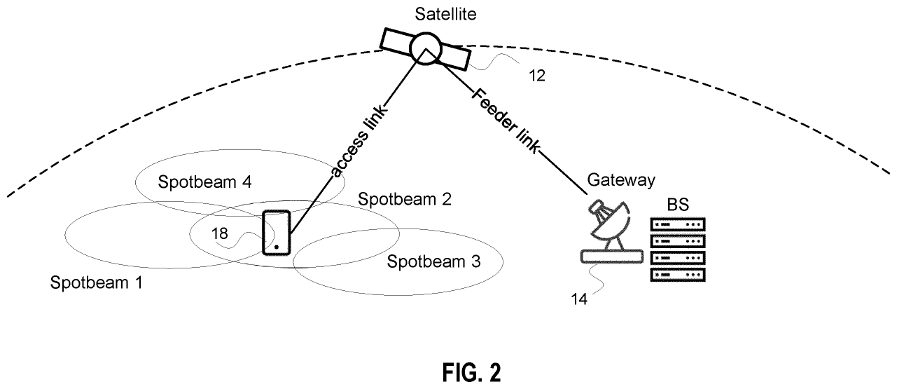

FIG. 2 shows an example architecture of a satellite network with bent pipe transponders. The NTN beam may in comparison to the beams observed in a terrestrial network be very wide and cover an area outside of the area defined by the served cell. Beam covering adjacent cells will overlap and cause significant levels of intercell interference. To overcome the large levels of interference a typical approach is a NTN to configure different cells with different carrier frequencies and polarization modes.

Consider now additional details of satellite assistance information according to some embodiments herein, e.g., where satellite assistance information may include satellite ephemeris information, epoch timing information, modified scheduling information, and/or timing advance information.

### Ephemeris Data

Ephemeris data (sometimes referred to as just “ephemeris”) is data that allows a UE (or other entity) to determine a satellite's position and velocity, i.e., the ephemeris data contains parameters related to the satellite's orbit. There are several different formats defined for ephemeris data.

Ephemeris data may be provided to the UE, for example to assist with pointing a directional antenna (or an antenna beam) towards the satellite, and to calculate a correct Timing Advance (TA) and Doppler shift. In New Radio (NR) NTN and IoT NTN, ephemeris data will be broadcast in the system information (SI) in each cell, included in an NTN specific System Information Block (SIB), (labeled SIB19 in NR NTN and SIB31 IoT NTN).

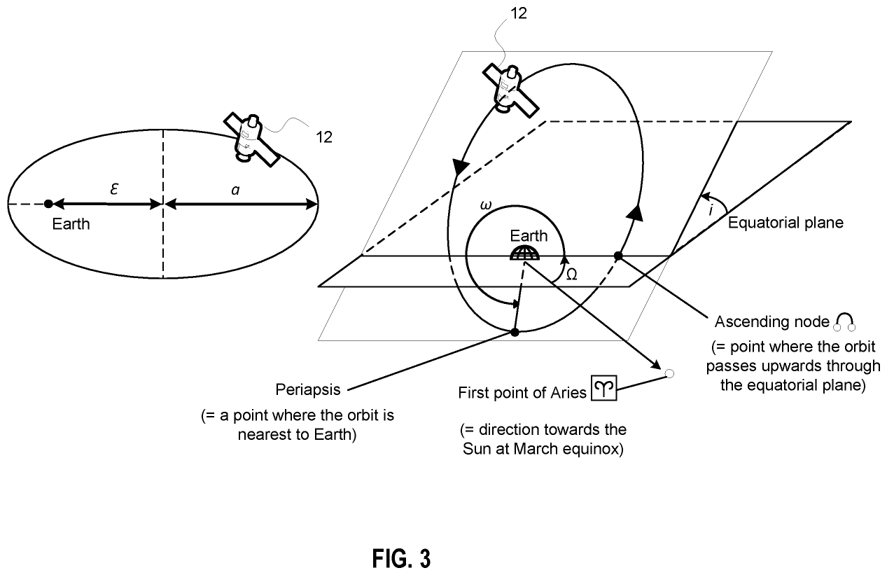

A satellite orbit can be fully described using 6 parameters. Exactly which set of parameters is chosen can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch time t determines a reference time (e.g. the time when the satellites moves through periapsis). This set of parameters is illustrated in FIG. 3.

As an example of a different parametrization, the TLEs use mean motion n and mean anomaly M instead of a and t. A completely different set of parameters is the position and velocity vector (x, y, z, vₓ, v_{y}, v_{z}) of a satellite. These are sometimes called orbital state vectors. They can be derived from the orbital elements and vice versa, since the information they contain is equivalent. All these formats (and many others) are possible choices for the format of ephemeris data to be used in NTN.

Consider now the validity time of ephemeris data. Predictions of satellite positions in general degrade with increasing age of the ephemeris data used, due to atmospheric drag, maneuvering of the satellite, imperfections in the orbital models used, etc. Therefore, the publicly available Two-Line Element (TLE) data are updated quite frequently. For example, the update frequency depends on the satellite and its orbit and ranges from weekly to multiple times a day for satellites on very low orbits which are exposed to strong atmospheric drag and need to perform correctional maneuvers often. Even more frequent updates will be used in NR NTN (and Internet-of-Things, IoT, NTN) to allow the UE to determine/predict the satellite's position (and velocity) accurately enough to satisfy the requirements in NTN, e.g., to enable a UE to calculate an accurate enough UE-specific TA.

### NTN-Specific Information in the System Information

Due to the special operating conditions in a Non-Terrestrial Network, the system information broadcast in an NTN cell may include NTN-specific information. To serve this purpose, a new SIB (SIB19) is introduced in NR NTN which contains NTN-specific information. In IoT NTN, the new SIB31 more or less corresponds to SIB19 in NR NTN. In 3GPP TS 38.331 version 17.0.0, SIB19 is defined as follows in ASN.1 code:

-- ASN1START
-- TAG-SIB19-START
SIB19-r17 ::= SEQUENCE {

| | | |
|---|---|---|
| ntn-Config | NTN-Config-r17 | OPTIONAL, -- Need R |
| t-Service-r17 | INTEGER (0..549755813887) | OPTIONAL, -- Need R |
| referenceLocation-r17 | ReferenceLocation-r17 | OPTIONAL, -- Need R |
| ta-Report-r17 | ENUMERATED {enabled} | OPTIONAL, -- Need R |
| lateNonCriticalExtension | OCTET STRING | OPTIONAL, |

...
}
ReferenceLocation-r17 ::= ENUMERATED { ffs } -- FFS
-- TAG-SIB19-STOP
-- ASN1STOP

SIB19 field descriptions

ntn-Config
Provides Ephemeris data, common TA parameters, koffset, validity duration for UL sync
information and epoch time when included in SIB19.
referenceLocation
Reference location of a cell provided via NTN quasi-Earth fixed system. FFS for exact
field description.
ta-Report
Indicates whether UE specific TA reporting is enabled during initial access (see TS
38.321, clause 5.4.8).
t-Service
Indicates the time information on when a cell provided via NTN quasi-Earth fixed system
is going to stop serving the area it is currently covering. The field counts the number of
UTC seconds in 10 ms units since 00:00:00 on Gregorian calendar date 1 January, 1900
(midnight between Sunday, December 31, 1899 and Monday, January 1, 1900).FFS” This
field is excluded when determining changes in system information, i.e. changes of t-
Service should neither result in system information change notifications nor in a
modification of valueTag in SIB1.”

Furthermore, the NTN-Config-r17 IE is defined as follows in ASN.1 code in the same specification:

-- ASN1START
-- TAG-NTN-CONFIG-START

| NTN-Config-r17 ::= | SEQUENCE { | |
|---|---|---|
| epochTime-r17 | EpochTime-r17 | OPTIONAL, -- Need R |

ntn-UISyncValidityDuration-r17 ENUMERATED{s5, s10, s15,

| | s20, s25, s30, s35, | |
|---|---|---|
| | s40, s45, s50, s55, | |
| | s60, s120, s180, s240} | OPTIONAL, -- Need R |
| cellSpecificKoffset-r17 | INTEGER(0..1023) | OPTIONAL, -- Need R |
| kmac-r17 | INTEGER(0..512) | OPTIONAL, -- Need R |
| ta-Info-r17 | TAInfo-r17 | OPTIONAL, -- Need R |
| ntn-PolarizationDL-r17 | ENUMERATED {rhcp,lhcp,linear} | OPTIONAL, -- Need R |
| ntn-PolarizationUL-r17 | ENUMERATED {rhcp,lhcp,linear} | OPTIONAL, -- Need R |
| ephemerisInfo-r17 | EphemerisInfo-r17 | OPTIONAL, -- Need R |

...
}

| | |
|---|---|
| EpochTime-r17 ::= | SEQUENCE { |
| sfn-r17 | INTEGER(0..1023), |
| subFrameNR-r17 | INTEGER(0..9) |

}

| TAInfo-r17 ::= | SEQUENCE { | |
|---|---|---|
| ta-Common-r17 | INTEGER(0..66485757), | |
| ta-CommonDrift-r17 | INTEGER(−261935..261935) | OPTIONAL, -- Need R |
| ta-CommonDriftVariant-r17 | INTEGER(0..29470) | OPTIONAL -- Need R |

}
-- TAG-NTN-CONFIG-STOP
-- ASN1STOP

NTN-Config field descriptions

EphemerisInfo
This field provides satellite ephemeris either in format of position and velocity state vector or
in format of orbital parameters. This field is excluded when determining changes in system
information, i.e. changes of XXX should neither result in system information change
notifications nor in a modification of valueTag in SIB1.
epochTime
Indicate the epoch time for assistance information (i.e. Serving satellite ephemeris in IE
ephemerisInfo and Common TA parameters). When explicitly provided through SIB, or
through dedicated signaling, EpochTime is the starting time of a DL sub-frame, indicated by
a SFN and a sub-frame number signaled together with the assistance information. The
reference point for epoch time of the serving satellite ephemeris and Common TA
parameters is the uplink time synchronization reference point. If this field is absent, the
epoch time is the end of SI window where this SIB19 is scheduled. This field is mandatory
present when provided in dedicated configuration.
cellSpecificKoffset
The CellSpecific_K_offset is a scheduling offset used for the timing relationships that need
to be modified for NTN [see TS 38.2xy]. The unit of K_offset is number of slots for a given
subcarrier spacing of 15 kHz. FFS other SCS.
kmac
K_mac is a scheduling offset provided by network if downlink and uplink frame timing are
not aligned at gNB. It is needed for UE action and assumption on downlink configuration
indicated by a MAC-CE command in PDSCH [see TS 38.2xy]. When UE is not provided by
network with a K_mac value, UE assumes K_mac = 0.
For the reference subcarrier spacing value for the unit of K_mac in FR1, a value of 15 kHz is
used. The unit of K_mac is number of slots for a given subcarrier spacing. FFS other SCS.
ntn-PolarizationDL
If present, this parameter indicates polarization information for Downlink transmission on
service link: including Right hand, Left hand circular polarizations (RHCP, LHCP) and Linear
polarization.
ntn-PolarizationUL
If present, this parameter indicates Polarization information for Uplink service link.
If not present and ntnPolarizationDL is present, UE assumes a same polarization for UL and
DL.
ntn-UISyncValidityDuration
A validity duration configured by the network for uplink synchronization assistance
information (i.e. Serving satellite ephemeris and Common TA parameters) which indicates
the maximum time during which the UE can apply assistance information without having
acquired new assistance information.
The unit of ntn-UISyncValidityDuration is second. This parameter applies to both connected
and idle mode UEs.
ta-Common
TACommon is a network-controlled common timing advanced value and it may include any
timing offset considered necessary by the network. TACommon with value of 0 is supported.
The granularity of TACommon is 4.07 × 10\hat{ }(−3) μs. Values are given in unit of
corresponding granularity. This field is excluded when determining changes in system
information, i.e. changes of XXX should neither result in system information change
notifications nor in a modification of valueTag in SIB1.”
taCommonDrift
Indicate drift rate of the common TA. The granularity of TACommonDrift is 0.2 × 10\hat{ }(−3)
μs/s Values are given in unit of corresponding granularity. This field is excluded when
determining changes in system information, i.e. changes of XXX should neither result in
system information change notifications nor in a modification of valueTag in SIB1.
taCommonDriftVariant
Indicate drift rate variation of the common TA. The granularity of TACommonDriftVariation is
0.2×10\hat{ }(−4) μs/s\hat{ }2. Values are given in unit of corresponding granularity. This field is
excluded when determining changes in system information, i.e. changes of XXX should
neither result in system information change notifications nor in a modification of valueTag in
SIB1.

And the EphemerisInfo IE is defined as follows in ASN.1 code in the same specification:

| -- ASN1START | |
|---|---|
| -- TAG-EPHEMERISINFO-START | |
| EphemerisInfo-r17 ::= | CHOICE { |
| positionVelocity-r17 | PositionVelocity-r17, |
| orbital-r17 | Orbital-r17 |
| } | |
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |
| } | |
| Orbital-r17 ::= | SEQUENCE { |
| semiMajorAxis-r17 | INTEGER (0..8589934591), |
| eccentricityE-r17 | INTEGER (0..524287), |
| periapsis-r17 | INTEGER (0..16777215), |
| longitude-r17 | INTEGER (0..2097151), |
| inclinationl-r17 | INTEGER (−524288..524287), |
| meanAnomalyM-r17 | INTEGER (0..16777215) |

}
PositionStateVector-r17 ::= INTEGER (−3355432..33554431)
VelocityStateVector-r17 ::= INTEGER (−131072..131071)
-- TAG-EPHEMERISINFO-STOP
-- ASN1STOP

EphemerisInfo field descriptions

anomaly
Satellite orbital parameter: Mean anomaly M at epoch time, see NIMA TR 8350.2 [X]. Unit
in radian.
Value range 0...2π by step of 2π * 2⁻²⁴. Actual value = IE value * ( 2 * π * 2⁻²⁴).
eccentricity
Satellite orbital parameter: eccentricity e, see NIMA TR 8350.2 [X].
Value range 0...0.015 by step of 0.015 * 2⁻¹⁹. Actual value = IE value * (0.015 * 2⁻¹⁹).
inclination
Satellite orbital parameter: inclination i, see NIMA TR 8350.2 [X]. Unit in radian.
Value range −π/2...π/2 by step of π/2 * 2⁻¹⁹. Actual value = IE value * ((π/2) * 2⁻¹⁹).
longitude
Satellite orbital parameter: longitude of ascending node Ω, see NIMA TR 8350.2 [X]. Unit
in radian.
Value range 0...2π by step of 2π * 2⁻²¹. Actual value = IE value * (2 * π * 2⁻²¹).
periapsis
Satellite orbital parameter: argument of periapsis ω, see NIMA TR 8350.2 [X]. Unit in
radian.
Value range 0...2π by step of 2π * 2⁻²⁴. Actual value = IE value * (2 * π * 2⁻²⁴).
positionX, positionY, positionZ
X, Y, Z coordinate of satellite position state vector in ECEF. Unit in meter.
Value range −42200000...42200000 by step of 1.3. Actual value = IE value * 1.3.
semiMajorAxis
Satellite orbital parameter: semi major axis α, see NIMA TR 8350.2 [X]. Unit in meter.
Value range 6500000....43000000 by step of 2⁻³³. Actual value = 6500000 + (43000000 −
6500000) * IE value * 2⁻³³.
velocityVX, velocityVY, velocityVZ
X, Y, Z coordinate of satellite velocity state vector in ECEF. Unit in meter/second.
Value range −8000...8000 by step of 0.06. Actual value = IE value * 0.06.

Satellite assistance information as used herein may include satellite information for measurement, including one or more of the following: Ephemeris, Epoch time, SMTCs, downlink polarization information, Serving cell stop time and reference location for IDLE mode measurement trigger in NGSO fixed cell, if applicable, feeder link delay (i.e., common TA and K_MAC) of the neighbor cell should also be provided to UE for neighbor cell SMTC adjustment, and/or separate validity timers. Alternatively or additionally, satellite assistance information as used herein may include satellite information for mobility, including one or more of the following: target cell Ephemeris information, Epoch time of the ephemeris, common TA, validity timer information for target cell mobility, DL and UL Polarization information, K_offset, Kmac (to determine UE-gNB RTT and perform RACH to target). In some embodiments, if the side condition is not met, requirements are not applied, i.e. extra delay won't be explicitly defined.

In some NR NTN embodiments, satellite assistance information for neighbor cells may be optionally included in SIB19. This includes satellite ephemeris and related information (ntn-Config-r17) but also the carrier frequency (carrierFreq-r17) or PCI (physCellId-r17). In some embodiments, a UE is not required to perform neighbor cell measurements if the corresponding satellite assistance information is not present. This may mean that, in order to have the UE perform neighbor cell measurements on a certain carrier frequency or PCI, the corresponding satellite assistance information must be transmitted. Problematically, though, ephemeris information, and/or other information per satellite, can be quite large, so it would be inefficient if the network had to transmit the same information multiple times if it happens that PCIs are associated with the same satellite.

Some embodiments herein provide efficient satellite assistance information transmission in this context. Some embodiments for example indicate which Physical Cell Identities (PCIs) are associated with the same satellite as the serving cell, whose information, e.g., ephemeris and/or any other, is known by the UE. This way, when a UE is configured to perform measurements on a certain carrier or certain PCIs, the UE may know which PCIs are associated with the same satellite, i.e., broadcast from the same satellite, and which are associated with neighbor satellite(s).

More particularly, some embodiments herein include several alternatives on how to provide the satellite assistance information, i.e., those that are provided in NTN-Config such as ephemeris information, epoch time, TA etc., for cells included in a Measurement Object that are associated with the same satellite as the serving cell. With the availability of such information, even if information about the satellite associated with a certain carrier frequency and/or PCI is not explicitly provided as part of the neighbor satellite assistance information broadcast in SIB19, a UE would not ignore the certain carrier frequency and/or PCI provided in the measurement configuration if the same satellite assistance information is provided for a different carrier frequency and/or PCI.

In one embodiment in this regard, an indication, e.g., a field parameter, or an implicit statement is introduced in Measurement Object, e.g., MeasObjectNR, which is provided as part of the measurement configuration, i.e., MeasConfig, to imply that for that particular measurement, e.g., on a particular frequency or for a particular PCI, satellite associated with such measurement is the same satellite associated with the serving cell measurements and thus serving satellite assistance information can be used. This indication is an example of the indication 25 in FIG. 1.

Certain embodiments may provide one or more of the following technical advantage(s). With the indication provided in a measurement object included in MeasConfig, or implicitly in a statement introduced as part of the measurement configuration, a UE can perform configured measurements, for example, on a certain frequency or for a certain PCI using the serving satellite assistance information even when information on the associated satellite is not provided explicitly in SIB19.

Considering that satellite assistance information, e.g., ephemeris information, epoch time, timing advance (TA), etc., can be quite large, this would also mean that SIB19 can be more efficient by providing satellite assistance information only for satellites that are different than the one associated with the serving cell.

In one embodiment, the following is captured in the field description of a Physical Cell Identifier (PCI list), e.g., one of the existing lists cellsToAddModList, allowedCells ToAddModList, of a measurement object: if a PCI in that list is not matching to a PCI for which neighbor satellite assistance information is given in SIB19 (and SS/PBCH Block Measurement Timing Configuration, SMTC, in SIB2/4), the UE shall assume that the PCI is associated with the same satellite as serving cell. In some sense, then, the PCI not matching to a PCI for which neighbor satellite assistance information is given in SIB19 (and SMTC in SIB2/4) functions as an example of the indication 25 in FIG. 1. Additionally, in another embodiment, the network 20 does not configure PCIs in that list unless the PCI is associated with the same satellite as the serving cell, or unless neighbor satellite assistance information corresponding to that PCI is given in SIB19. In an alternative or additional embodiment, the field description of excludedCells ToAddModList within MO is enhanced to describe that these PCIs do not belong to the same satellite and do not have associated ephemeris data. Generally, then, some embodiments herein use the existing lists in the measurement object to define which PCIs UE may or may not have ephemeris info, that is NTN-config (other terminology could be satellite assistance information/data or equivalent) present in the system information, either SIB19 or SIB2/4 or other SIB. This is to assist the UE regarding which PCI has the info and which does not. The benefit of this embodiment is that it would not require any changes in the current signaling, i.e., ASN.1, but rather enhances the meaning of the values in that signaling.

In another embodiment, which also does not require ASN.1 code changes, the field description of neighbor satellite assistance information list in SIB19 is modified. Whenever satellite assistance information (ntn-Config-r17) is omitted in the list, the listed PCIs are associated with the same satellite as current serving cell. In some sense, then, satellite assistance information (ntn-Config-r17) being omitted in the list serves as the indication 25 in FIG. 1. In a variant, only the first entries in the list until the first entry including satellite assistance information (ntn-config-r17) are considered to correspond to the serving satellite. In another embodiment, a new list of PCIs is introduced in a measurement object (MO) which indicates the PCIs that are associated with the satellite same as the serving cell. This new list functions in this example as the indication 25 in FIG. 1.

In an alternative embodiment, in existing PCI list (one of those), an optional flag is added corresponding to a PCI which indicates whether the PCI is associated with the satellite same as the serving cell or not. This optional flag functions in this example as the indication 25 in FIG. 1. Regardless, in this case, the network can either give or not give the assistance information of a neighbor satellite for the rest of the PCIs and UE may or may not ignore the measurements. That is, for the PCIs that have been flagged to belong to same satellite, UE can use serving satellite ephemeris, and for rest of PCIs UE will need to check existence of neighbor satellite info.

In another embodiment, in Measurement Object's existing PCI list, an optional numerical field associated to a specific PCI is added to indicate the position of the satellite assistance information in SIB19 for both serving and neighbor satellites. For instance, value 0 may correspond to the serving satellite, value 1 to the first satellite in NTN-NeighCellConfig-r17, and so on until the maximum of 8. This numerical field accordingly serves as the indication 25 of FIG. 1 in this example. In a variant, this numerical field number refers to all PCIs included in the Measurement Object and is added as an extension to cellsToAddModList or allowedCellsToAddModList field, i.e., so that multiple lists that correspond to the numerical field can be provided

In one embodiment, a PCI list which informs UEs about PCIs that are associated with the same satellite is added to SIB19. This PCI list serves as the indication 25 in FIG. 1 in this example.

In a dependent embodiment, it is added where serving satellite information is provided, or as another dependent embodiment it is given within the IE where neighbor cell information is provided.

Some embodiments herein refer to and/or propose modifications to the following parameters, fields, or information elements (IE).

### SIB19

SIB19 contains satellite assistance information for NTN access.

SIB19 information element

-- ASN1START
-- TAG-SIB19-START
SIB19-r17 ::= SEQUENCE {

| | | |
|---|---|---|
| ntn-Config-r17 | NTN-Config-r17 | OPTIONAL, -- |

Need R

| | | |
|---|---|---|
| t-Service-r17 | INTEGER (0..549755813887) | OPTIONAL, -- Need |

R

| | | |
|---|---|---|
| referenceLocation-r17 | ReferenceLocation-r17 | OPTIONAL, -- Need R |
| distanceThresh-r17 | INTEGER(0..65525) | OPTIONAL, -- Need R |
| ntn-NeighCellConfigList-r17 | NTN-NeighCellConfigList-r17 | OPTIONAL, -- Need R |
| lateNonCriticalExtension | OCTET STRING | OPTIONAL, |

```
  ...,
  [[
```

| | | |
|---|---|---|
| ntn-NeighCellConfigListExt-v1720 | NTN-NeighCellConfigList-r17 | OPTIONAL -- Need R |

]]
}

| | |
|---|---|
| NTN-NeighCellConfigList-r17 ::= | SEQUENCE (SIZE(1..maxCellNTN-r17)) OF NTN- |

NeighCellConfig-r17

| NTN-NeighCellConfig-r17 ::= | SEQUENCE { | |
|---|---|---|
| ntn-Config-r17 | NTN-Config-r17 | OPTIONAL, -- Need R |
| carrierFreq-r17 | ARFCN-ValueNR | OPTIONAL, -- Need R |
| physCellId-r17 | PhysCellId | OPTIONAL -- Need R |

}
-- TAG-SIB19-STOP
-- ASN1STOP

SIB19 field descriptions

distanceThresh
Distance from the serving cell reference location and is used in location-based
measurement initiation in RRC_IDLE and RRC_INACTIVE, as defined in TS 38.304.
Each step represents 50m.
ntn-Config
Provides parameters needed for the UE to access NR via NTN access such as
Ephemeris data, common TA parameters, k_offset, validity duration for UL sync
information and epoch.
ntn-NeighCellConfigList, ntn-NeighCellConfigListExt
Provides a list of NTN neighbour cells including their ntn-Config, carrier frequency and
PhysCellID. This set includes all elements of ntn-NeighCellConfigList and all elements
of ntn-NeighCellConfigListExt. If ntn-Config is absent for an entry in ntn-
NeighCellConfigListExt, the ntn-Config provided in the entry at the same position in
ntn-NeighCellConfigList applies.
referenceLocation
Reference location of the serving cell provided via NTN quasi-Earth fixed system and
is used in location-based measurement initiation in RRC_IDLE and RRC_INACTIVE,
as defined in TS 38.304.
t-Service
Indicates the time information on when a cell provided via NTN quasi-Earth fixed
system is going to stop serving the area it is currently covering. The field indicates a
time in multiples of 10 ms after 00:00:00 on Gregorian calendar date 1 January, 1900
(midnight between Sunday, December 31, 1899 and Monday, January 1, 1900). The
exact stop time is between the time indicated by the value of this field minus 1 and the
time indicated by the value of this field.

The IE NTN-Config provides parameters needed for the UE to access NR via NTN access. The IE NTN-Config includes one example of satellite assistance information.

NTN-Config information element

-- ASN1START
-- TAG-NTN-CONFIG-START

| NTN-Config-r17 ::= | SEQUENCE { | |
|---|---|---|
| epochTime-r17 | EpochTime-r17 | OPTIONAL, -- Need R |

ntn-UISyncValidityDuration-r17 ENUMERATED{ s5, s10, s15, s20, s25, s30, s35,

| | s40, s45, s50, s55, s60, s120, s180, s240, s900} | |
|---|---|---|
| | OPTIONAL, -- Cond SIB19 | |
| cellSpecificKoffset-r17 | INTEGER(1..1023) | OPTIONAL, -- Need R |
| kmac-r17 | INTEGER(1..512) | OPTIONAL, -- Need R |
| ta-Info-r17 | TA-Info-r17 | OPTIONAL, -- Need R |
| ntn-PolarizationDL-r17 | ENUMERATED {rhcp,lhcp,linear} | OPTIONAL, -- Need R |
| ntn-PolarizationUL-r17 | ENUMERATED {rhcp,lhcp,linear} | OPTIONAL, -- Need R |
| ephemerisInfo-r17 | EphemerisInfo-r17 | OPTIONAL, -- Need R |
| ta-Report-r17 | ENUMERATED {enabled} | OPTIONAL, -- Need R |

...
}

| | |
|---|---|
| EpochTime-r17 ::= | SEQUENCE { |
| sfn-r17 | INTEGER(0..1023), |
| subFrameNR-r17 | INTEGER(0..9) |

}

| TA-Info-r17 ::= | SEQUENCE { | |
|---|---|---|
| ta-Common-r17 | INTEGER(0..66485757), | |
| ta-CommonDrift-r17 | INTEGER(−257303..257303) | OPTIONAL, -- Need R |
| ta-CommonDriftVariant-r17 | INTEGER(0..28949) | OPTIONAL -- Need R |

}
-- TAG-NTN-CONFIG-STOP
-- ASN1STOP

NTN-Config field descriptions

EphemerisInfo
This field provides satellite ephemeris either in format of position and
velocity state vector or in format of orbital parameters. This field is excluded
when determining changes in system information, i.e. changes to
ephemerisInfo should neither result in system information change
notifications nor in a modification of valueTag in SIB1.
epochTime
Indicate the epoch time for the NTN assistance information. When explicitly
provided through SIB, or through dedicated signaling, EpochTime is the
starting time of a DL sub-frame, indicated by a SFN and a sub-frame number
signaled together with the assistance information. The reference point for
epoch time of the serving satellite ephemeris and Common TA parameters is
the uplink time synchronization reference point. If this field is absent, the
epoch time is the end of SI window where this SIB19 is scheduled. This field
is mandatory present when provided in dedicated configuration. If this field is
absent in ntn-Config provided via NTN-NeighCellConfig the UE uses epoch
time from the serving satellite ephemeris, otherwise the field is based on the
timing of the serving cell, i.e. the SFN and sub-frame number indicated in
this field refers to the SFN and sub-frame of the serving cell. In case of
handover, this field is based on the timing of the target cell, i.e. the SFN and
sub-frame number indicated in this field refers to the SFN and sub-frame of
the target cell. This field is excluded when determining changes in system
information, i.e. changes to epochTime should neither result in system
information change notifications nor in a modification of valueTag in SIB1.
cellSpecificKoffset
Scheduling offset used for the timing relationships that are modified for NTN
[see TS 38.211]. The unit of the field K_offset is number of slots for a given
subcarrier spacing of 15 kHz. If the field is absent UE assumes value 0.
kmac
Scheduling offset provided by network if downlink and uplink frame timing
are not aligned at gNB. It is needed for UE action and assumption on
downlink configuration indicated by a MAC CE command in PDSCH [see TS
38.2xy]. If the field is absent UE assumes value 0.
For the reference subcarrier spacing value for the unit of K_mac in FR1, a
value of 15 kHz is used. The unit of K_mac is number of slots for a given
subcarrier spacing.
ntn-PolarizationDL
If present, this parameter indicates polarization information for downlink
transmission on service link: including Right hand, Left hand circular
polarizations (RHCP, LHCP) and Linear polarization.
ntn-PolarizationUL
If present, this parameter indicates Polarization information for Uplink
service link.
If not present and ntn-PolarizationDL is present, UE assumes the same
polarization for UL and DL.
ntn-UISyncValidityDuration
A validity duration configured by the network for assistance information (i.e.
Serving and/or neighbour satellite ephemeris and Common TA parameters)
which indicates the maximum time during which the UE can apply
assistance information without having acquired new assistance information.
The unit of ntn-UISyncValidityDuration is second. Value s5 corresponds to 5
s, value s10 indicate 10 s and so on. This parameter applies to both
connected and idle mode UEs. If this field is absent in ntn-Config provided
via NTN-NeighCellConfig, the UE uses validity duration from the serving cell
assistance information. This field is excluded when determining changes in
system information, i.e. changes of ntn-UISyncValidityDuration should
neither result in system information change notifications nor in a modification
of valueTag in SIB1. ntn-UISyncValidityDuration is only updated when at
least one of epochTime, ta-Info, ephemerisInfo is updated.
ta-Common
Network-controlled common timing advanced value and it may include any
timing offset considered necessary by the network. ta-Common with value of
0 is supported. The granularity of ta-Common is 4.072 × 10\hat{ }(−3) μs. Values
are given in unit of corresponding granularity. This field is excluded when
determining changes in system information, i.e. changes of ta-Common
should neither result in system information change notifications nor in a
modification of valueTag in SIB1.
ta-CommonDrift
Indicate drift rate of the common TA. The granularity of ta-CommonDrift is
0.2 × 10\hat{ }(−3) μs/s Values are given in unit of corresponding granularity.
This field is excluded when determining changes in system information, i.e.
changes of ta-CommonDrift should neither result in system information
change notifications nor in a modification of valueTag in SIB1.
ta-CommonDriftVariant
Indicate drift rate variation of the common TA. The granularity of ta-
CommonDriftVariation is 0.2×10\hat{ }(−4) μs/s\hat{ }2. Values are given in unit of
corresponding granularity. This field is excluded when determining changes
in system information, i.e. changes of ta-CommonDriftVariant should neither
result in system information change notifications nor in a modification of
valueTag in SIB1.
ta-Report
When this field is included in SIB19, it indicates reporting of timing advanced
is enabled during Random Access due to RRC connection establishment or
RRC connection resume, and during RRC connection reestablishment ..
When this field is included in ServingCellConfigCommon within dedicated
signalling, it indicates TA reporting is enabled during Random Access due to
reconfiguration with sync (see TS 38.321, clause 5.4.8).

In some embodiments, a measurement configuration includes measurement objects: A list of objects on which the UE shall perform the measurements.

For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.

The measObjectId of the MO which corresponds to each serving cell is indicated by servingCellMO within the serving cell configuration.

For inter-radio access technology (inter-RAT) Evolved UMTS Terrestrial Radio Access (E-UTRA) measurements, a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.

For inter-RAT UTRA-Frequency Division Duplexing (FDD) measurements a measurement object is a set of cells on a single UTRA-FDD carrier frequency.

For NR sidelink measurements of L2 U2N Relay UEs, a measurement object is a single NR sidelink frequency to be measured

### MeasConfig

The IE MeasConfig specifies measurements to be performed by the UE, and covers intra-frequency, inter-frequency and inter-RAT mobility as well as configuration of measurement gaps.

MeasConfig information element

-- ASN1START
-- TAG-MEASCONFIG-START

| MeasConfig ::= | SEQUENCE { | |
|---|---|---|
| measObjectToRemoveList | MeasObjectToRemoveList | OPTIONAL, -- Need N |
| measObjectToAddModList | MeasObjectToAddModList | OPTIONAL, -- Need N |
| reportConfigToRemoveList | ReportConfigToRemoveList | OPTIONAL, -- Need N |
| reportConfigToAddModList | ReportConfigToAddModList | OPTIONAL, -- Need N |
| measIdToRemoveList | MeasIdToRemoveList | OPTIONAL, -- Need N |
| measIdToAddModList | MeasIdToAddModList | OPTIONAL, -- Need N |

| | |
|---|---|
| s-MeasureConfig | CHOICE { |
| ssb-RSRP | RSRP-Range, |
| csi-RSRP | RSRP-Range |

} OPTIONAL, -- Need M

| | | |
|---|---|---|
| quantityConfig | QuantityConfig | OPTIONAL, -- Need M |
| measGapConfig | MeasGapConfig | OPTIONAL, -- Need M |
| measGapSharingConfig | MeasGapSharingConfig | OPTIONAL, -- Need M |

```
  ...,
  [[
```

| | |
|---|---|
| interFrequencyConfig-NoGap-r16 | ENUMERATED {true |

OPTIONAL -- Need R
]]
}

| | |
|---|---|
| MeasObjectToRemoveList ::= | SEQUENCE (SIZE (1..maxNrofObjectId)) OF |

MeasObjectId

| | |
|---|---|
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId
-- TAG-MEASCONFIG-STOP
-- ASN1STOP

MeasConfig field descriptions

interFrequencyConfig-NoGap-r16
If the field is set to true, UE is configured to perform SSB based inter-frequency
measurement without measurement gaps when the inter-frequency Synchronization
Signal Block (SSB) is completely contained in the active downlink (DL) bandwidth part
(BWP) of the UE, as specified in TS 38.133, clause 9.3. Otherwise, the SSB based inter-
frequency measurement is performed within measurement gaps. In NR- Dual
Connectivity (DC), the field can only be configured in the measConfig associated with
Master Cell Group (MCG), and when configured, it applies to all the inter-frequency
measurements configured by Master Node (MN) and Secondary Node (SN).
measGapConfig
Used to setup and release measurement gaps in NR.
measIdToAddModList
List of measurement identities to add and/or modify.
measIdToRemoveList
List of measurement identities to remove.
measObjectToAddModList
List of measurement objects to add and/or modify.
measObjectToRemoveList
List of measurement objects to remove.
reportConfigToAddModList
List of measurement reporting configurations to add and/or modify.
reportConfigToRemoveList
List of measurement reporting configurations to remove.
s-MeasureConfig
Threshold for NR SpCell Reference Signal Received Power (RSRP) measurement
controlling when the UE is required to perform measurements on non-serving cells.
Choice of ssb-RSRP corresponds to cell RSRP based on SS/PBCH block and choice of
csi-RSRP corresponds to cell RSRP of Channel State Information Reference Signal
(CSI-RS).
measGapSharingConfig
Specifies the measurement gap sharing scheme and controls setup/ release of
measurement gap sharing.

The IE MeasObjectToAddModList concerns a list of measurement objects to add or modify.

MeasObjectToAddModList information element

-- ASN1START
-- TAG-MEASOBJECTTOADDMODLIST-START

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16 |

}
}
-- TAG-MEASOBJECTTOADDMODLIST-STOP
-- ASN1STOP

Note the terms beam and cell may be used interchangeably herein, unless explicitly noted otherwise. Some embodiments herein are focused on NTN in the context of Internet of Things (IoT), but embodiments herein apply to any wireless network dominated by line-of-sight conditions.

As used herein, the term Non-Terrestrial Network (NTN) may, depending on the context, refer to either or both of NR NTN and IoT NTN, and sometimes the term is used to refer to only NR NTN.

Some embodiments herein are described mainly in terms of NR based NTNs, but they are equally applicable in an NTN based on Long Term Evolution (LTE) technology (and in particular IoT NTN).

The term “network” is used in some embodiments to refer to a network node, which may be a radio access network (RAN) node such as a gNB (e.g. in a NR based NTN) or an eNB (e.g. in an LTE based NTN, such as an IoT NTN), but which may also be a base station or an access point in another type of network, or any other network node with the ability to directly or indirectly communicate with a UE. Refinements with finer granularity are also conceivable. For instance, a gNB may be an en-gNB, and if a split gNB architecture is applied (dividing the gNB into multiple separate entities or notes), the term “node” may refer to a part of the gNB, such as a gNB-CU (often referred to as just central unit, CU), a gNB-DU (often referred to as just distributed unit, DU), a gNB-CU-CP or a gNB-CU-UP. Similarly, an eNB may be an ng-eNB, and if a split eNB architecture is applied (dividing the gNB into multiple separate entities or notes), the term “network” (and the network node it implies) may refer to a part of the eNB, such as an eNB-CU, an eNB-DU, an eNB-CU-CP or an eNB-CU-UP. Here, CP refers to control plane and UP refers to user plane. Furthermore, the term “network” (and the network node it implies) may also refer to an IAB-donor, IAB-donor-CU, IAB-donor-DU, IAB-donor-CU-CP, or an IAB-donor-CU-UP. Here, IAB refers to Integrated Access Backhaul.

The terms NTN-specific information and satellite assistance information are used interchangeably.

The terminology is written from NR NTN specification perspective but applies to lot NTN as well even SIB names or other field names might be different. That is there is corresponding element for NR NTN and IoT NTN with different name,

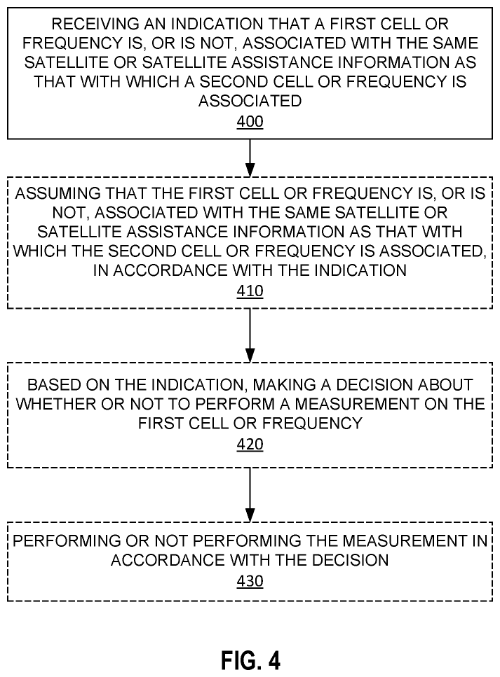

In view of the modifications and variations herein, FIG. 4 depicts a method performed by a communication device 16 configured for use in a communication network 10, in accordance with particular embodiments. The method includes receiving an indication 25 that a first cell or frequency 18-1 is, or is not, associated with the same satellite 12 or satellite assistance information 24-1, 24-2 as that with which a second cell or frequency 18-2 is associated (Block 400).

In some embodiments, the method also includes assuming that the first cell or frequency 18-1 is, or is not, associated with the same satellite 12 or satellite assistance information 24-1, 24-2 as that with which the second cell or frequency 18-2 is associated, in accordance with the indication 25 (Block 410).

In some embodiments, the method also includes, based on the indication 25, making a decision about whether or not to perform a measurement on the first cell or frequency 18-1 (Block 420).

In some embodiments, the method also includes performing or not performing the measurement in accordance with the decision (Block 430).

In some embodiments, the method also includes receiving satellite assistance information 24-2 for the second cell or frequency. In some embodiments, the method also includes, based on the indication 25, performing a measurement on the first cell or frequency 18-1 using the satellite assistance information 24-2 received for the second cell or frequency 18-2.

In some embodiments, the second cell or frequency 18-2 is a serving cell of the communication device or a carrier frequency of the serving cell. In some embodiments, the first cell or frequency 18-1 is a measurement object that is an object of a measurement to be performed by the communication device, and the indication 25 is included in a measurement configuration 26 that specifies a measurement to be performed by the communication device on the first cell or frequency 18-1.

In some embodiments, the second cell or frequency 18-2 is a serving cell of the communication device or a carrier frequency of the serving cell. In some embodiments, the indication 25 indicates that the satellite or satellite assistance information associated with the first cell or frequency 18-1 is the same as that with which the second cell or frequency 18-2 is associated. In some embodiments, the method further comprises receiving a list of one or more identifiers identifying one or more cells or frequencies on which the communication device is to perform a measurement, wherein the list of one or more identifiers includes a first identifier identifying the first cell or frequency 18-1. In some embodiments, the method further comprises receiving, for each of one or more neighbor identifiers that respectively identify one or more neighbor cells or frequencies, satellite assistance information associated with that neighbor cell or frequency. In some embodiments, the indication 25 is that the first identifier does not match any neighbor identifier for which the communication device has received satellite assistance information.

In some embodiments, the second cell or frequency 18-2 is a serving cell or frequency. In some embodiments, the first cell or frequency 18-1 is a neighbor cell or frequency. In some embodiments, the indication 25 indicates that the satellite or satellite assistance information associated with the neighbor cell or frequency is the same as that associated with the serving cell or frequency. In some embodiments, the method further comprises receiving a neighbor cell configuration information element for the neighbor cell or frequency. In some embodiments, the neighbor cell configuration information element includes a neighbor identifier identifying the neighbor cell or frequency but excludes satellite assistance information. In some embodiments, the indication 25 is that the neighbor cell configuration information element excludes satellite assistance information.

In some embodiments, the method further comprises receiving a list of one or more identifiers identifying one or more cells or frequencies, including the first cell or frequency 18-1, that are each associated with the same satellite or satellite assistance information as that with which the second cell or frequency 18-2 is associated. In some embodiments, the indication 25 is the identifier of the first cell or frequency 18-1 being included in the list.

In some embodiments, the indication 25 is a flag associated with an identifier of the first cell or frequency 18-1 indicating that the satellite or satellite assistance information associated with the first cell or frequency 18-1 is the same as that with which the second cell or frequency 18-2 is associated.

In some embodiments, the method further comprises receiving a message that includes satellite assistance information for a serving cell or frequency and that further includes satellite assistance information for each of one or more neighbor cells or frequencies. In some embodiments, the indication 25 is a pointer associated with the first cell or frequency 18-1 pointing to satellite assistance information in the message that is associated with the first cell or frequency 18-1.

In some embodiments, the second cell or frequency 18-2 is a serving cell of the communication device or a carrier frequency of the serving cell, and the first cell or frequency 18-1 is a neighbor cell or a carrier frequency of the neighbor cell.

In some embodiments, the method further comprises receiving signaling that explicitly includes satellite assistance information for one or more cells or frequencies, including the second cell or frequency 18-2. In some embodiments, the indication 25 is that the signaling does not explicitly include satellite assistance information for the first cell or frequency 18-1.

In some embodiments, the indication 25 indicates that the satellite or satellite assistance information associated with the first cell or frequency 18-1 is the same as that associated with the second cell or frequency 18-2, and the method further comprises, based on the indication 25, performing a measurement on the first cell or frequency 18-1 using satellite assistance information associated with the second cell or frequency 18-2.

In some embodiments, satellite assistance information associated with a cell or frequency includes satellite ephemeris information, epoch timing information, modified scheduling information, and/or timing advance information to assist the communication device to access the cell or frequency via a satellite.

In some embodiments, the indication 25 indicates that the same satellite provides both the first cell or frequency 18-1 and the second cell or frequency 18-2.

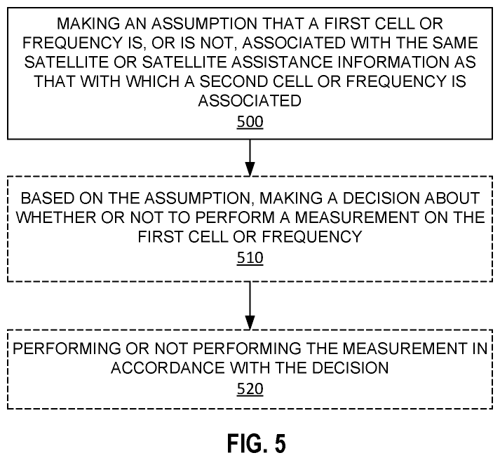

FIG. 5 depicts a method performed by a communication device 16 configured for use in a communication network 10 in accordance with other particular embodiments. The method includes making an assumption that a first cell or frequency 18-1 is, or is not, associated with the same satellite 12 or satellite assistance information 24-1, 24-2 as that with which a second cell or frequency 18-2 is associated (Block 500).

In some embodiments, the method also includes, based on the assumption, making a decision about whether or not to perform a measurement on the first cell or frequency 18-1 (Block 510).

In some embodiments, the method also includes performing or not performing the measurement in accordance with the decision (Block 520).

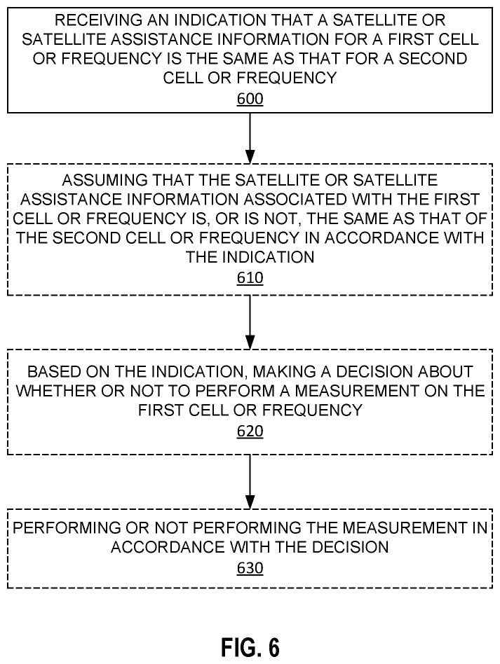

FIG. 6 depicts a method performed by a communication device in accordance with other particular embodiments. The method includes receiving an indication 25 that a satellite 12 or satellite assistance information 24-1 for a first cell or frequency 18-1 is the same as a satellite 12 or satellite assistance information 24-2 for a second cell or frequency 18-2 (Block 600).

In some embodiments, the method also includes assuming that the satellite 12 or satellite assistance information 24-1 for the first cell or frequency 18-1 is, or is not, the same as the satellite 12 or satellite assistance information 24-2 of the second cell or frequency 18-2 in accordance with the indication 25 (Block 610).

In some embodiments, the method also includes, based on the indication 25, making a decision about whether or not to perform a measurement on the first cell or frequency 18-1 (Block 620).

In some embodiments, the method also includes performing or not performing the measurement in accordance with the decision (Block 630).

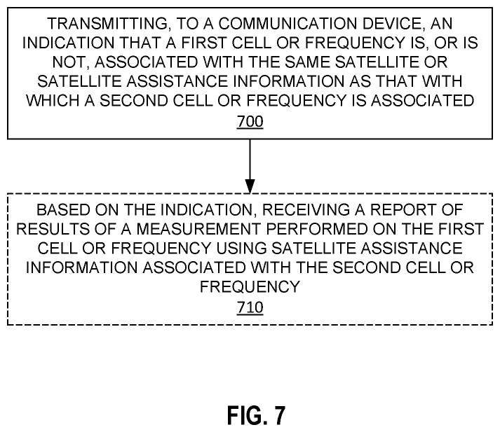

FIG. 7 depicts a method performed by a network node 20 configured for use in a communication network 10 in accordance with other particular embodiments. The method includes transmitting, to a communication device 16, an indication 25 that a first cell or frequency 18-1 is, or is not, associated with the same satellite 12 or satellite assistance information 24-1, 24-2 as that with which a second cell or frequency 18-2 is associated (Block 700).

In some embodiments, the method also includes, based on the indication 25, receiving a report of results of a measurement performed on the first cell or frequency 18-1 using satellite assistance information 24-2 associated with the second cell or frequency 18-2 (Block 710).

In some embodiments, the second cell or frequency 18-2 is a serving cell of the communication device or a carrier frequency of the serving cell. In some embodiments, the first cell or frequency 18-1 is a measurement object that is an object of a measurement to be performed by the communication device, and the indication 25 is included in a measurement configuration 26 that specifies a measurement to be performed by the communication device on the first cell or frequency 18-1.

In some embodiments, the second cell or frequency 18-2 is a serving cell of the communication device or a carrier frequency of the serving cell. In some embodiments, the indication 25 indicates that the satellite or satellite assistance information associated with the first cell or frequency 18-1 is the same as that with which the second cell or frequency 18-2 is associated. In some embodiments, the method further comprises transmitting a list of one or more identifiers identifying one or more cells or frequencies on which the communication device is to perform a measurement. In some embodiments, the list of one or more identifiers includes a first identifier identifying the first cell or frequency 18-1. In some embodiments, the method further comprises transmitting, for each of one or more neighbor identifiers that respectively identify one or more neighbor cells or frequencies, satellite assistance information associated with that neighbor cell or frequency. In some embodiments, the indication 25 is that the first identifier does not match any neighbor identifier for which the communication device has received satellite assistance information.

In some embodiments, the second cell or frequency 18-2 is a serving cell or frequency. In some embodiments, the first cell or frequency 18-1 is a neighbor cell or frequency. In some embodiments, the indication 25 indicates that the satellite or satellite assistance information associated with the neighbor cell or frequency is the same as that associated with the serving cell or frequency. In some embodiments, the method further comprises transmitting a neighbor cell configuration information element for the neighbor cell or frequency. In some embodiments, the neighbor cell configuration information element includes a neighbor identifier identifying the neighbor cell or frequency but excludes satellite assistance information. In some embodiments, the indication 25 is that the neighbor cell configuration information element excludes satellite assistance information.

In some embodiments, the method further comprises transmitting a list of one or more identifiers identifying one or more cells or frequencies, including the first cell or frequency 18-1, that are each associated with the same satellite or satellite assistance information as that with which the second cell or frequency 18-2 is associated. In some embodiments, the indication 25 is the identifier of the first cell or frequency 18-1 being included in the list.

In some embodiments, the indication 25 is a flag associated with an identifier of the first cell or frequency 18-1 indicating that the satellite or satellite assistance information associated with the first cell or frequency 18-1 is the same as that with which the second cell or frequency 18-2 is associated.

In some embodiments, the method further comprises receiving a message that includes satellite assistance information for a serving cell or frequency and that further includes satellite assistance information for each of one or more neighbor cells or frequencies. In some embodiments, the indication 25 is a pointer associated with the first cell or frequency 18-1 pointing to satellite assistance information in the message that is associated with the first cell or frequency 18-1.

In some embodiments, the second cell or frequency 18-2 is a serving cell of the communication device or a carrier frequency of the serving cell, and the first cell or frequency 18-1 is a neighbor cell or a carrier frequency of the neighbor cell.

In some embodiments, the method further comprises transmitting signaling that explicitly includes satellite assistance information for one or more cells or frequencies, including the second cell or frequency 18-2. In some embodiments, the indication 25 is that the signaling does not explicitly include satellite assistance information for the first cell or frequency 18-1.

In some embodiments, the indication 25 indicates that the satellite or satellite assistance information associated with the first cell or frequency 18-1 is the same as that associated with the second cell or frequency 18-2.

In some embodiments, satellite assistance information associated with a cell or frequency includes satellite ephemeris information, epoch timing information, modified scheduling information, and/or timing advance information to assist the communication device to access the cell or frequency via a satellite.

In some embodiments, the indication 25 indicates that the same satellite provides both the first cell or frequency 18-1 and the second cell or frequency 18-2.

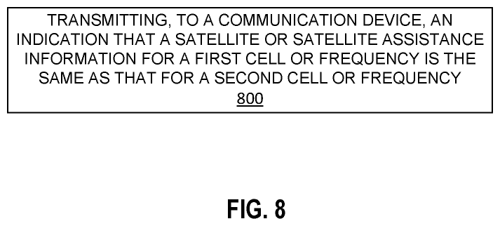

FIG. 8 depicts a method performed by a network node 20 configured for use in a communication network 10 in accordance with other particular embodiments. The method includes transmitting, to a communication device 16, an indication 25 that a satellite 12 or satellite assistance information 24-1 for a first cell or frequency 18-1 is the same as that for a second cell or frequency 18-2 (Block 800).

Embodiments herein also include corresponding apparatuses. Embodiments herein for instance include a communication device 16 configured to perform any of the steps of any of the embodiments described above for the communication device 16.

Embodiments also include a communication device 16 comprising processing circuitry and power supply circuitry. The processing circuitry is configured to perform any of the steps of any of the embodiments described above for the communication device 16. The power supply circuitry is configured to supply power to the communication device 16.

Embodiments further include a communication device 16 comprising processing circuitry. The processing circuitry is configured to perform any of the steps of any of the embodiments described above for the communication device 16. In some embodiments, the communication device 16 further comprises communication circuitry.

Embodiments further include a communication device 16 comprising processing circuitry and memory. The memory contains instructions executable by the processing circuitry whereby the communication device 16 is configured to perform any of the steps of any of the embodiments described above for the communication device 16.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 16. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 20 configured to perform any of the steps of any of the embodiments described above for the network node 20.

Embodiments also include a network node 20 comprising processing circuitry and power supply circuitry. The processing circuitry is configured to perform any of the steps of any of the embodiments described above for the network node 20. The power supply circuitry is configured to supply power to the network node 20.

Embodiments further include a network node 20 comprising processing circuitry. The processing circuitry is configured to perform any of the steps of any of the embodiments described above for the network node 20. In some embodiments, the network node 20 further comprises communication circuitry.

Embodiments further include a network node 20 comprising processing circuitry and memory. The memory contains instructions executable by the processing circuitry whereby the network node 20 is configured to perform any of the steps of any of the embodiments described above for the network node 20.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

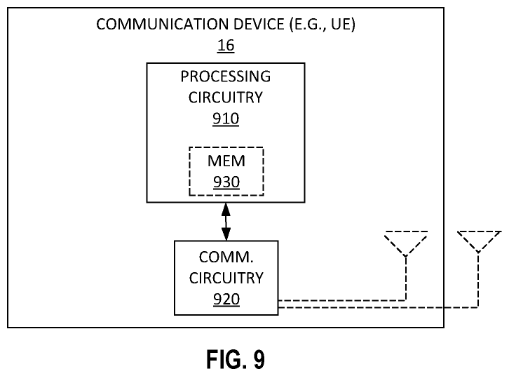

FIG. 9 for example illustrates a communication device 16 as implemented in accordance with one or more embodiments. As shown, the communication device 16 includes processing circuitry 910 and communication circuitry 920. The communication circuitry 920 (e.g., radio circuitry) is configured to transmit and/or receive information to and/or from one or more other nodes, e.g., via any communication technology. Such communication may occur via one or more antennas that are either internal or external to the communication device 16. The processing circuitry 910 is configured to perform processing described above, e.g., in FIG. 4, FIG. 5, and/or FIG. 6, such as by executing instructions stored in memory 930. The processing circuitry 910 in this regard may implement certain functional means, units, or modules.

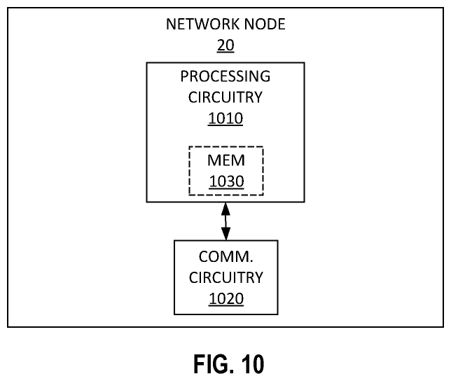

FIG. 10 illustrates a network node 20 as implemented in accordance with one or more embodiments. As shown, the network node 1000 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, e.g., in FIG. 7 and/or FIG. 8, such as by executing instructions stored in memory 1030. The processing circuitry 1010 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

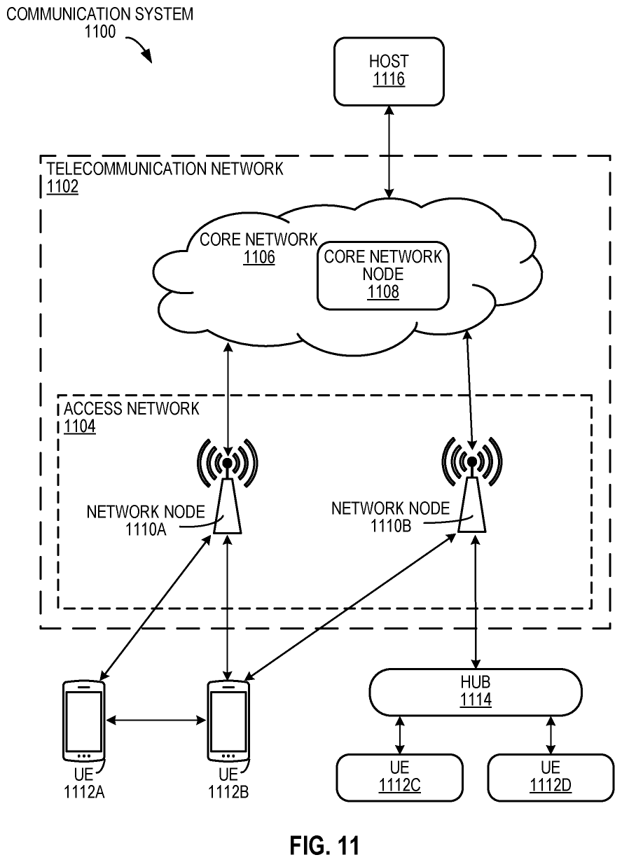

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3^{rd} Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

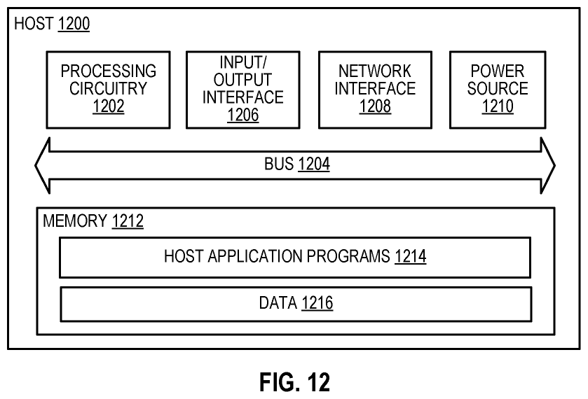

FIG. 12 is a block diagram of a host 1200, which may be an embodiment of the host 1116 of FIG. 11, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

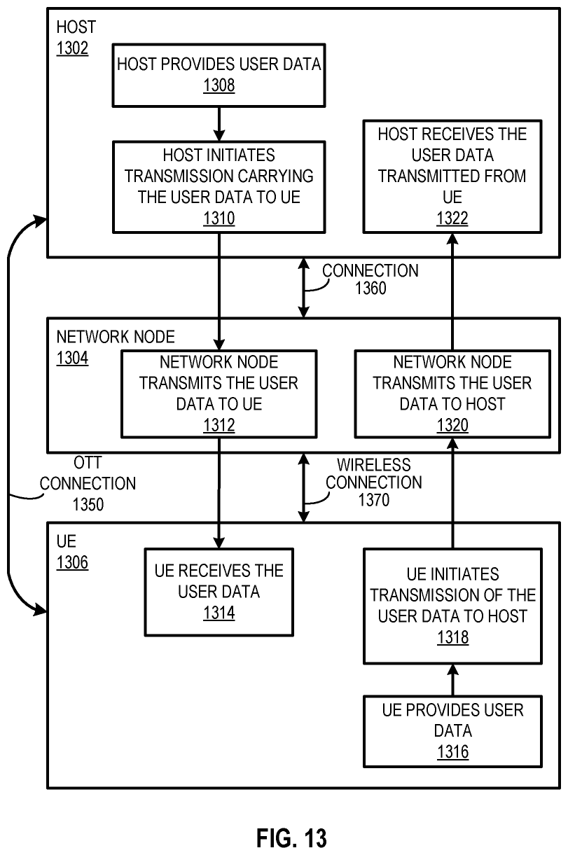

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 12 and 13, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1200 of FIG. 12) discussed in the preceding paragraphs will now be described with reference to FIG. 13.

Like host 1200, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 1106 of FIG. 11) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some embodiments herein are enumerated as follows:

### Group A Embodiments

A1. A method performed by a communication device (16) configured for use in a communication network (10), the method comprising:
receiving an indication (25) that a first cell or frequency (18-1) is, or is not, associated with the same satellite or satellite assistance information (24-1, 24-2) as that with which a second cell or frequency (18-2) is associated.
   A2. The method of embodiment A1, wherein the second cell or frequency (18-2) is a serving cell of the communication device or a carrier frequency of the serving cell.
   A3. The method of any of embodiments A1-A2, wherein the first cell or frequency (18-1) is a measurement object that is an object of a measurement to be performed by the communication device.
   A4. The method of any of embodiments A1-A3, wherein the indication (25) is included in a measurement configuration (26) that specifies a measurement to be performed by the communication device on the first cell or frequency (18-1).
   A5. The method of any of embodiments A1-A4, wherein the indication (25) is included in a measurement object information element that includes information about the first cell or frequency (18-1) on which the communication device is to perform a measurement.
   A6. The method of any of embodiments A1-A5, wherein the second cell or frequency (18-2) is a serving cell of the communication device or a carrier frequency of the serving cell, wherein the indication (25) indicates that the first cell or frequency (18-1) is associated with the same satellite or satellite assistance information as that of the serving cell or the carrier frequency of the serving cell, wherein the method further comprises:
receiving a list of one or more identifiers identifying one or more cells or frequencies on which the communication device is to perform a measurement, wherein the list of one or more identifiers includes a first identifier identifying the first cell or frequency (18-1);
receiving, for each of one or more neighbor identifiers that respectively identify one or more neighbor cells or frequencies, satellite assistance information associated with that neighbor cell or frequency;
wherein the indication (25) is that the first identifier does not match any neighbor identifier for which the communication device has received satellite assistance information.
   A7. The method of embodiment A6, wherein receiving, for each of one or more neighbor identifiers that respectively identify one or more neighbor cells or frequencies, satellite assistance information associated with that neighbor cell or frequency comprises receiving a list of one or more neighbor cell configurations, wherein each neighbor cell configuration in the list includes a neighbor identifier that identifies a neighbor cell or frequency and also includes satellite assistance information associated with the neighbor cell or frequency.
   A8. The method of any of embodiments A6-A7, wherein the satellite assistance information is received in System Information.
   A9. The method of any of embodiments A6-A8, wherein the satellite assistance information is received in System Information Block #19, SIB19, or a System Information Block #31, SIB31.
   A10. The method of any of embodiments A6-A9, wherein the list of one or more identifiers identifying one or more cells or frequencies on which the communication device is to perform a measurement is included in a cellsToAddModList field or an allowedCellsToAddModList field.
   A11. The method of any of embodiments A1-A5, wherein the second cell or frequency (18-2) is a serving cell or frequency, wherein the first cell or frequency (18-1) is a neighbor cell or frequency, wherein the indication (25) indicates that the neighbor cell or frequency is associated with the same satellite or satellite assistance information as that of the serving cell or frequency, wherein the method further comprises receiving a neighbor cell configuration information element for the neighbor cell or frequency, wherein the neighbor cell configuration information element includes a neighbor identifier identifying the neighbor cell or frequency but excludes satellite assistance information, wherein the indication (25) is that the neighbor cell configuration information element excludes satellite assistance information.
   A12. The method of embodiment A11, wherein the neighbor cell configuration information element is an NTN-NeighCellConfig-r17 information element, wherein the NTN-NeighCellConfig-r17 information element includes physCellId-r17 identifying the serving cell or includes carrierFreq-r17 identifying the serving frequency but excludes ntn-Config-r17 as the satellite assistance information.
   A13. The method of any of embodiments A1-A5, wherein the method further comprises receiving a list of one or more identifiers identifying one or more cells or frequencies, including the first cell or frequency (18-1), that are each associated with the same satellite or satellite assistance information as that with which the second cell or frequency (18-2) is associated, wherein the indication (25) is the identifier of the first cell or frequency (18-1) being included in the list.
   A14. The method of embodiment A13, wherein the list of one or more identifiers is included in a measurement configuration (26) or a measurement object information element.
   A15. The method of embodiment A13, wherein the list of one or more identifiers is included in System Information.
   A16. The method of embodiment A13, wherein the list of one or more identifiers is included in System Information Block #19, SIB19, or a System Information Block #31, SIB31.
   A17. The method of embodiment A13, wherein the list of one or more identifiers is included in an information element that includes serving satellite information or neighbor cell information.
   A18. The method of any of embodiments A1-A5, wherein the indication (25) is a flag associated with an identifier of the first cell or frequency (18-1) indicating that the first cell or frequency (18-1) is associated with the same satellite or satellite assistance information as that with which the second cell or frequency (18-2) is associated.
   A19. The method of embodiment A18, wherein the second cell or frequency (18-2) is a serving cell of the communication device or a carrier frequency of the serving cell, wherein the method further comprises receiving a list of one or more identifiers identifying one or more cells or frequencies, including the first cell or frequency (18-1), wherein each of at least one of the one or more identifiers in the list is associated with a respective flag indicating whether or not the cell or frequency identified by the identifier is associated with the same satellite or satellite assistance information as that with which the second cell or frequency (18-2) is associated.
   A20. The method of any of embodiments A1-A5, further comprising receiving a message that includes satellite assistance information for a serving cell or frequency and that further includes satellite assistance information for each of one or more neighbor cells or frequencies, wherein the indication (25) is a pointer associated with the first cell or frequency (18-1) pointing to satellite assistance information in the message that is associated with the first cell or frequency (18-1).
   A21. The method of embodiment A20, wherein each of the satellite assistance information for the serving cell or frequency and the satellite assistance information for each of the one or more neighbor cells or frequencies is mapped to a numeric value, wherein the pointer is the numeric value that is mapped to the satellite assistance information in the message that is associated with the first cell or frequency (18-1).
   A22. The method of embodiment A21, wherein each of the satellite assistance information for the serving cell or frequency and the satellite assistance information for each of the one or more neighbor cells or frequencies is mapped to a numeric value that corresponds to an ordering of the satellite assistance information in the message.
   A23. The method of any of embodiments A20-A22, wherein the message is a System Information message.
   A24. The method of any of embodiments A20-A23, wherein the message is or conveys a System Information Block #19, SIB19, or a System Information Block #31, SIB31.
   A25. The method of any of embodiments A20-A24, wherein the indication (25) is received in a measurement configuration (26) or a measurement object.
   A26. The method of any of embodiments A20-A25, wherein the pointer is specific to the first cell or frequency (18-1).
   A27. The method of any of embodiments A20-A25, wherein the pointer is common to multiple cells or frequencies such that the pointer points to satellite assistance information in the message that is associated with each of the multiple cells or frequencies.
   A28. The method of any of embodiments A1-A27, wherein the second cell or frequency (18-2) is a serving cell of the communication device or a carrier frequency of the serving cell, and wherein the first cell or frequency (18-1) is a neighbor cell or a carrier frequency of the neighbor cell.
   A29. The method of any of embodiments A1-A5, further comprising receiving signaling that explicitly includes satellite assistance information for one or more cells or frequencies, including the second cell or frequency (18-2), wherein the indication (25) is that the signaling does not explicitly include satellite assistance information for the first cell or frequency (18-1).
   A30. The method of any of embodiments A1-A29, further comprising assuming that the first cell or frequency (18-1) is, or is not, associated with the same satellite or satellite assistance information as that with which the second cell or frequency (18-2) is associated in accordance with the indication (25).
   A31. The method of any of embodiments A1-A29, wherein the indication (25) indicates that the first cell or frequency (18-1) is associated with the same satellite or satellite assistance information as that with which the second cell or frequency (18-2) is associated.
   A32. The method of embodiment A31, further comprising, based on the indication (25), performing a measurement on the first cell or frequency (18-1) using satellite assistance information associated with the second cell or frequency (18-2).
   A33. The method of any of embodiments A1-A29, wherein the indication (25) indicates that the first cell or frequency (18-1) is not associated with the same satellite or satellite assistance information as that with which the second cell or frequency (18-2) is associated.
   A34. The method of embodiment A33, further comprising, based on determining from the indication (25) that the communication device lacks satellite assistance information associated with the first cell or frequency (18-1), refraining from performing a measurement on the first cell or frequency (18-1).
   A35. The method of embodiment A1, further comprising receiving a list of one or more identifiers identifying one or more cells or frequencies that are each not associated with the same satellite or satellite assistance information as that with which the second cell or frequency (18-2) is associated, wherein the indication (25) that the first cell or frequency (18-1) is not associated with the same satellite or satellite assistance information as that with which the second cell or frequency (18-2) is associated is the identifier identifying the first cell or frequency (18-1) being included in the list.
   A36. The method of embodiment A35, wherein the list is received in a measurement configuration (26) or a measurement object.
   A37. The method of any of embodiments A35-A36, wherein the list is or is conveyed by an excludedCells ToAddModList.
   A38. The method of any of embodiments A1-A37, wherein satellite assistance information associated with a cell or frequency includes one or more parameters for the communication device to access the cell or frequency via a satellite.
   A39. The method of any of embodiments A1-A38, wherein satellite assistance information associated with a cell or frequency includes satellite ephemeris information, epoch timing information, modified scheduling information, and/or timing advance information to assist the communication device to access the cell or frequency via a satellite.
   A40. The method of any of embodiments A1-A39, further comprising:
based on the indication (25), making a decision about whether or not to perform a measurement on the first cell or frequency (18-1); and
performing or not performing the measurement in accordance with the decision.
   A41. The method of any of embodiments A1-A40, wherein the communication network is a non-terrestrial network.
   A42. The method of any of embodiments A1-A41, wherein the indication (25) indicates that the same satellite provides both the first cell or frequency (18-1) and the second cell or frequency (18-2).
   AA1. A method performed by a communication device configured for use in a communication network, the method comprising:
making an assumption that a first cell or frequency (18-1) is, or is not, associated with the same satellite or satellite assistance information (24-1, 24-2) as that with which a second cell or frequency (18-2) is associated.
   AA2. The method of embodiment AA1, wherein the second cell or frequency (18-2) is a serving cell of the communication device or a carrier frequency of the serving cell.
   AA3. The method of any of embodiments AA1-AA2, wherein the first cell or frequency (18-1) is a measurement object that is an object of a measurement to be performed by the communication device.
   AA4. The method of any of embodiments AA1-AA3, further comprising receiving a measurement configuration (26) that specifies a measurement to be performed by the communication device on the first cell or frequency (18-1).
   AA5. The method of any of embodiments AA1-AA4, further comprising receiving a measurement object information element that includes information about the first cell or frequency (18-1) on which the communication device is to perform a measurement.
   AA6. The method of any of embodiments AA1-AA5, wherein the second cell or frequency (18-2) is a serving cell of the communication device or a carrier frequency of the serving cell, wherein the assumption is that the first cell or frequency (18-1) is associated with the same satellite or satellite assistance information as that of the serving cell or the carrier frequency of the serving cell, wherein the method further comprises:
receiving a list of one or more identifiers identifying one or more cells or frequencies on which the communication device is to perform a measurement, wherein the list of one or more identifiers includes a first identifier identifying the first cell or frequency (18-1);
receiving, for each of one or more neighbor identifiers that respectively identify one or more neighbor cells or frequencies, satellite assistance information associated with that neighbor cell or frequency;
wherein the assumption is made responsive to determining that the first identifier does not match any neighbor identifier for which the communication device has received satellite assistance information.
   AA7. The method of embodiment AA6, wherein receiving, for each of one or more neighbor identifiers that respectively identify one or more neighbor cells or frequencies, satellite assistance information associated with that neighbor cell or frequency comprises receiving a list of one or more neighbor cell configurations, wherein each neighbor cell configuration in the list includes a neighbor identifier that identifies a neighbor cell or frequency and also includes satellite assistance information associated with the neighbor cell or frequency.
   AA8. The method of any of embodiments AA6-AA7, wherein the satellite assistance information is received in System Information.
   AA9. The method of any of embodiments AA6-AA8, wherein the satellite assistance information is received in System Information Block #19, SIB19, or a System Information Block #31, SIB31.
   AA10. The method of any of embodiments AA6-AA9, wherein the list of one or more identifiers identifying one or more cells or frequencies on which the communication device is to perform a measurement is included in a cellsToAddModList field or an allowedCells ToAddModList field.
   AA11. The method of any of embodiments AA1-AA5, wherein the second cell or frequency (18-2) is a serving cell or frequency, wherein the first cell or frequency (18-1) is a neighbor cell or frequency, wherein the assumption is that the neighbor cell or frequency is associated with the same satellite or satellite assistance information as that of the serving cell or frequency, wherein the method further comprises receiving a neighbor cell configuration information element for the neighbor cell or frequency, wherein the neighbor cell configuration information element includes a neighbor identifier identifying the neighbor cell or frequency but excludes satellite assistance information, wherein the assumption is made responsive to determining that the neighbor cell configuration information element excludes satellite assistance information.
   AA12. The method of embodiment AA11, wherein the neighbor cell configuration information element is an NTN-NeighCellConfig-r17 information element, wherein the NTN-NeighCellConfig-r17 information element includes physCellId-r17 identifying the serving cell or includes carrierFreq-r17 identifying the serving frequency but excludes ntn-Config-r17 as the satellite assistance information.
   AA13. The method of any of embodiments AA1-AA5, wherein the method further comprises receiving a list of one or more identifiers identifying one or more cells or frequencies, including the first cell or frequency (18-1), that are each associated with the same satellite or satellite assistance information as that with which the second cell or frequency (18-2) is associated, wherein the assumption is made based on determining that the identifier of the first cell or frequency (18-1) is included in the list.
   AA14. The method of embodiment AA13, wherein the list of one or more identifiers is included in a measurement configuration (26) or a measurement object information element.
   AA15. The method of embodiment AA13, wherein the list of one or more identifiers is included in System Information.
   AA16. The method of embodiment AA13, wherein the list of one or more identifiers is included in System Information Block #19, SIB19, or a System Information Block #31, SIB31.
   AA17. The method of embodiment AA13, wherein the list of one or more identifiers is included in an information element that includes serving satellite information or neighbor cell information.
   AA18. The method of any of embodiments AA1-AA5, wherein the assumption is made based on a flag associated with an identifier of the first cell or frequency (18-1) indicating that the first cell or frequency (18-1) is associated with the same satellite or satellite assistance information as that with which the second cell or frequency (18-2) is associated.
   AA19. The method of embodiment AA18, wherein the second cell or frequency (18-2) is a serving cell of the communication device or a carrier frequency of the serving cell, wherein the method further comprises receiving a list of one or more identifiers identifying one or more cells or frequencies, including the first cell or frequency (18-1), wherein each of at least one of the one or more identifiers in the list is associated with a respective flag indicating whether or not the cell or frequency identified by the identifier is associated with the same satellite or satellite assistance information as that with which the second cell or frequency (18-2) is associated.
   AA20. The method of any of embodiments AA1-AA5, further comprising receiving a message that includes satellite assistance information for a serving cell or frequency and that further includes satellite assistance information for each of one or more neighbor cells or frequencies, wherein the assumption is made based on a pointer associated with the first cell or frequency (18-1) pointing to satellite assistance information in the message that is associated with the first cell or frequency (18-1).
   AA21. The method of embodiment AA20, wherein each of the satellite assistance information for the serving cell or frequency and the satellite assistance information for each of the one or more neighbor cells or frequencies is mapped to a numeric value, wherein the pointer is the numeric value that is mapped to the satellite assistance information in the message that is associated with the first cell or frequency (18-1).
   AA22. The method of embodiment AA21, wherein each of the satellite assistance information for the serving cell or frequency and the satellite assistance information for each of the one or more neighbor cells or frequencies is mapped to a numeric value that corresponds to an ordering of the satellite assistance information in the message.
   AA23. The method of any of embodiments AA20-AA22, wherein the message is a System Information message.
   AA24. The method of any of embodiments AA20-AA23, wherein the message is or conveys a System Information Block #19, SIB19, or a System Information Block #31, SIB31.
   AA25. The method of any of embodiments AA20-AA24, wherein the pointer is received in a measurement configuration (26) or a measurement object.
   AA26. The method of any of embodiments AA20-AA25, wherein the pointer is specific to the first cell or frequency (18-1).
   AA27. The method of any of embodiments AA20-AA25, wherein the pointer is common to multiple cells or frequencies such that the pointer points to satellite assistance information in the message that is associated with each of the multiple cells or frequencies.
   AA28. The method of any of embodiments AA1-AA27, wherein the second cell or frequency (18-2) is a serving cell of the communication device or a carrier frequency of the serving cell, and wherein the first cell or frequency (18-1) is a neighbor cell or a carrier frequency of the neighbor cell.
   AA29. The method of any of embodiments AA1-AA5, further comprising receiving signaling that explicitly includes satellite assistance information for one or more cells or frequencies, including the second cell or frequency (18-2), wherein the assumption is made based on the signaling not explicitly including satellite assistance information for the first cell or frequency (18-1).

### AA30. Reserved.

AA31. The method of any of embodiments AA1-AA29, wherein the assumption is that the first cell or frequency (18-1) is associated with the same satellite or satellite assistance information as that with which the second cell or frequency (18-2) is associated.
AA32. The method of embodiment AA31, further comprising, based on the assumption, performing a measurement on the first cell or frequency (18-1) using satellite assistance information associated with the second cell or frequency (18-2).
AA33. The method of any of embodiments AA1-A2A9, wherein the assumption is that the first cell or frequency (18-1) is not associated with the same satellite or satellite assistance information as that with which the second cell or frequency (18-2) is associated.
AA34. The method of embodiment AA33, further comprising, based on the assumption, refraining from performing a measurement on the first cell or frequency (18-1).

AA35. The method of embodiment AA1, further comprising receiving a list of one or more identifiers identifying one or more cells or frequencies that are each not associated with the same satellite or satellite assistance information as that with which the second cell or frequency (18-2) is associated, wherein the assumption is made based on the identifier identifying the first cell or frequency (18-1) being included in the list.

AA36. The method of embodiment AA35, wherein the list is received in a measurement configuration (26) or a measurement object.
AA37. The method of any of embodiments AA35-AA36, wherein the list is or is conveyed by an excludedCellsToAddModList.
AA38. The method of any of embodiments AA1-AA37, wherein satellite assistance information associated with a cell or frequency includes one or more parameters for the communication device to access the cell or frequency via a satellite.
AA39. The method of any of embodiments AA1-AA38, wherein satellite assistance information associated with a cell or frequency includes satellite ephemeris information, epoch timing information, modified scheduling information, and/or timing advance information to assist the communication device to access the cell or frequency via a satellite.
AA40. The method of any of embodiments AA1-AA39, further comprising:
based on the assumption, making a decision about whether or not to perform a measurement on the first cell or frequency (18-1); and
performing or not performing the measurement in accordance with the decision.
   AA41. The method of any of embodiments AA1-AA40, wherein the communication network is a non-terrestrial network.
   AAA1. A method performed by a communication device, the method comprising:
receiving an indication (25) that a satellite (12) or satellite assistance information (24-1) for a first cell or frequency (18-1) is the same as that (12, 24-2) for a second cell or frequency (18-2).
   AAA2. The method of embodiment AAA1, wherein the second cell or frequency (18-2) is a serving cell of the communication device or a carrier frequency of the serving cell.
   AAA3. The method of any of embodiments AAA1-AAA2, wherein the first cell or frequency (18-1) is a measurement object that is an object of a measurement to be performed by the communication device.
   AAA4. The method of any of embodiments AAA1-AAA3, wherein the indication (25) is included in a measurement configuration (26) that specifies a measurement to be performed by the communication device on the first cell or frequency (18-1).
   AAA5. The method of any of embodiments AAA1-AAA4, wherein the indication (25) is included in a measurement object information element that includes information about the first cell or frequency (18-1) on which the communication device is to perform a measurement.
   AAA6. The method of any of embodiments AAA1-AAA5, wherein the second cell or frequency (18-2) is a serving cell of the communication device or a carrier frequency of the serving cell, wherein the indication (25) indicates that the satellite or satellite assistance information associated with the first cell or frequency (18-1) is the same as that with which the second cell or frequency (18-2) is associated, wherein the method further comprises:
receiving a list of one or more identifiers identifying one or more cells or frequencies on which the communication device is to perform a measurement, wherein the list of one or more identifiers includes a first identifier identifying the first cell or frequency (18-1);
receiving, for each of one or more neighbor identifiers that respectively identify one or more neighbor cells or frequencies, satellite assistance information associated with that neighbor cell or frequency;
wherein the indication (25) is that the first identifier does not match any neighbor identifier for which the communication device has received satellite assistance information.
   AAA7. The method of embodiment AAA6, wherein receiving, for each of one or more neighbor identifiers that respectively identify one or more neighbor cells or frequencies, satellite assistance information associated with that neighbor cell or frequency comprises receiving a list of one or more neighbor cell configurations, wherein each neighbor cell configuration in the list includes a neighbor identifier that identifies a neighbor cell or frequency and also includes satellite assistance information associated with the neighbor cell or frequency.
   AAA8. The method of any of embodiments AAA6-AAA7, wherein the satellite assistance information is received in System Information.
   AAA9. The method of any of embodiments AAA6-AAA8, wherein the satellite assistance information is received in System Information Block #19, SIB19, or a System Information Block #31, SIB31.
   AAA10. The method of any of embodiments AAA6-AAA9, wherein the list of one or more identifiers identifying one or more cells or frequencies on which the communication device is to perform a measurement is included in a cellsToAddModList field or an allowedCellsToAddModList field.
   AAA11. The method of any of embodiments AAA1-AAA5, wherein the second cell or frequency (18-2) is a serving cell or frequency, wherein the first cell or frequency (18-1) is a neighbor cell or frequency, wherein the indication (25) indicates that the satellite or satellite assistance information associated with the neighbor cell or frequency is the same as that associated with the serving cell or frequency, wherein the method further comprises receiving a neighbor cell configuration information element for the neighbor cell or frequency, wherein the neighbor cell configuration information element includes a neighbor identifier identifying the neighbor cell or frequency but excludes satellite assistance information, wherein the indication (25) is that the neighbor cell configuration information element excludes satellite assistance information.
   AAA12. The method of embodiment AAA11, wherein the neighbor cell configuration information element is an NTN-NeighCellConfig-r17 information element, wherein the NTN-NeighCellConfig-r17 information element includes physCellId-r17 identifying the serving cell or includes carrierFreq-r17 identifying the serving frequency but excludes ntn-Config-r17 as the satellite assistance information.
   AAA13. The method of any of embodiments AAA1-AAA5, wherein the method further comprises receiving a list of one or more identifiers identifying one or more cells or frequencies, including the first cell or frequency (18-1), that are each associated with the same satellite or satellite assistance information as that with which the second cell or frequency (18-2) is associated, wherein the indication (25) is the identifier of the first cell or frequency (18-1) being included in the list.
   AAA14. The method of embodiment AAA13, wherein the list of one or more identifiers is included in a measurement configuration (26) or a measurement object information element.
   AAA15. The method of embodiment AAA13, wherein the list of one or more identifiers is included in System Information.
   AAA16. The method of embodiment AAA13, wherein the list of one or more identifiers is included in System Information Block #19, SIB19, or a System Information Block #31, SIB31.
   AAA17. The method of embodiment AAA13, wherein the list of one or more identifiers is included in an information element that includes serving satellite information or neighbor cell information.
   AAA18. The method of any of embodiments AAA1-AAA5, wherein the indication (25) is a flag associated with an identifier of the first cell or frequency (18-1) indicating that the satellite or satellite assistance information associated with the first cell or frequency (18-1) is the same as that with which the second cell or frequency (18-2) is associated.
   AAA19. The method of embodiment AAA18, wherein the second cell or frequency (18-2) is a serving cell of the communication device or a carrier frequency of the serving cell, wherein the method further comprises receiving a list of one or more identifiers identifying one or more cells or frequencies, including the first cell or frequency (18-1), wherein each of at least one of the one or more identifiers in the list is associated with a respective flag indicating whether or not the satellite or satellite assistance information associated with the cell or frequency identified by the identifier is the same as that with which the second cell or frequency (18-2) is associated.
   AAA20. The method of any of embodiments AAA1-AAA5, further comprising receiving a message that includes satellite assistance information for a serving cell or frequency and that further includes satellite assistance information for each of one or more neighbor cells or frequencies, wherein the indication (25) is a pointer associated with the first cell or frequency (18-1) pointing to satellite assistance information in the message that is associated with the first cell or frequency (18-1).
   AAA21. The method of embodiment AAA20, wherein each of the satellite assistance information for the serving cell or frequency and the satellite assistance information for each of the one or more neighbor cells or frequencies is mapped to a numeric value, wherein the pointer is the numeric value that is mapped to the satellite assistance information in the message that is associated with the first cell or frequency (18-1).
   AAA22. The method of embodiment AAA21, wherein each of the satellite assistance information for the serving cell or frequency and the satellite assistance information for each of the one or more neighbor cells or frequencies is mapped to a numeric value that corresponds to an ordering of the satellite assistance information in the message.
   AAA23. The method of any of embodiments AAA20-AAA22, wherein the message is a System Information message.
   AAA24. The method of any of embodiments AAA20-AAA23, wherein the message is or conveys a System Information Block #19, SIB19, or a System Information Block #31, SIB31.
   AAA25. The method of any of embodiments AAA20-AAA24, wherein the indication (25) is received in a measurement configuration (26) or a measurement object.
   AAA26. The method of any of embodiments AAA20-AAA25, wherein the pointer is specific to the first cell or frequency (18-1).
   AAA27. The method of any of embodiments AAA20-AAA25, wherein the pointer is common to multiple cells or frequencies such that the pointer points to satellite assistance information in the message that is associated with each of the multiple cells or frequencies.
   AAA28. The method of any of embodiments AAA1-AAA27, wherein the second cell or frequency (18-2) is a serving cell of the communication device or a carrier frequency of the serving cell, and wherein the first cell or frequency (18-1) is a neighbor cell or a carrier frequency of the neighbor cell.
   AAA29. The method of any of embodiments AAA1-AAA5, further comprising receiving signaling that explicitly includes satellite assistance information for one or more cells or frequencies, including the second cell or frequency (18-2), wherein the indication (25) is that the signaling does not explicitly include satellite assistance information for the first cell or frequency (18-1).
   AAA30. The method of any of embodiments AAA1-AAA29, further comprising assuming that the satellite or satellite assistance information associated with the first cell or frequency (18-1) is, or is not, the same as that with which the second cell or frequency (18-2) is associated in accordance with the indication (25).
   AAA31. The method of any of embodiments AAA1-AAA29, wherein the indication (25) indicates that the satellite or satellite assistance information associated with the first cell or frequency (18-1) is the same as that associated with the second cell or frequency (18-2).
   AAA32. The method of embodiment AAA31, further comprising, based on the indication (25), performing a measurement on the first cell or frequency (18-1) using satellite assistance information associated with the second cell or frequency (18-2).
   AAA33. The method of any of embodiments AAA1-A2AA9, wherein the indication (25) indicates that the satellite or satellite assistance information associated with the first cell or frequency (18-1) is not the same as that associated with the second cell or frequency (18-2).
   AAA34. The method of embodiment AAA33, further comprising, based on determining from the indication (25) that the communication device lacks satellite assistance information associated with the first cell or frequency (18-1), refraining from performing a measurement on the first cell or frequency (18-1).
   AAA35. The method of embodiment AAA1, further comprising receiving a list of one or more identifiers identifying one or more cells or frequencies that are each not associated with the same satellite or satellite assistance information as that with which the second cell or frequency (18-2) is associated, wherein the indication (25) that the satellite or satellite assistance information associated with the first cell or frequency (18-1) is not the same as that associated with the second cell or frequency (18-2) is the identifier identifying the first cell or frequency (18-1) being included in the list.
   AAA36. The method of embodiment AAA35, wherein the list is received in a measurement configuration (26) or a measurement object.
   AAA37. The method of any of embodiments AAA35-AAA36, wherein the list is or is conveyed by an excludedCellsToAddModList.
   AAA38. The method of any of embodiments AAA1-AAA37, wherein satellite assistance information associated with a cell or frequency includes one or more parameters for the communication device to access the cell or frequency via a satellite.
   AAA39. The method of any of embodiments AAA1-AAA38, wherein satellite assistance information associated with a cell or frequency includes satellite ephemeris information, epoch timing information, modified scheduling information, and/or timing advance information to assist the communication device to access the cell or frequency via a satellite.
   AAA40. The method of any of embodiments AAA1-AAA39, further comprising:
based on the indication (25), making a decision about whether or not to perform a measurement on the first cell or frequency (18-1); and
performing or not performing the measurement in accordance with the decision.
   AAA41. The method of any of embodiments AAA1-AAA40, wherein the communication network is a non-terrestrial network.
   AAA42. The method of any of embodiments AAA1-AAA41, wherein the indication (25) indicates that the same satellite provides both the first cell or frequency (18-1) and the second cell or frequency (18-2).
   AA. The method of any of the previous embodiments, further comprising:
providing user data; and forwarding the user data to a host computer via the transmission to a base station.

### Group B Embodiments

B1. A method performed by a network node configured for use in a communication network, the method comprising:
transmitting, to a communication device, an indication (25) that a first cell or frequency (18-1) is, or is not, associated with the same satellite or satellite assistance information (24-1, 24-2) as that with which a second cell or frequency (18-2) is associated.
   B2. The method of embodiment B1, wherein the second cell or frequency (18-2) is a serving cell of the communication device or a carrier frequency of the serving cell.
   B3. The method of any of embodiments B1-B2, wherein the first cell or frequency (18-1) is a measurement object that is an object of a measurement to be performed by the communication device.
   B4. The method of any of embodiments B1-B3, wherein the indication (25) is included in a measurement configuration (26) that specifies a measurement to be performed by the communication device on the first cell or frequency (18-1).
   B5. The method of any of embodiments B1-B4, wherein the indication (25) is included in a measurement object information element that includes information about the first cell or frequency (18-1) on which the communication device is to perform a measurement.
   B6. The method of any of embodiments B1-B5, wherein the second cell or frequency (18-2) is a serving cell of the communication device or a carrier frequency of the serving cell, wherein the indication (25) indicates that the first cell or frequency (18-1) is associated with the same satellite or satellite assistance information as that of the serving cell or the carrier frequency of the serving cell, wherein the method further comprises:
transmitting a list of one or more identifiers identifying one or more cells or frequencies on which the communication device is to perform a measurement, wherein the list of one or more identifiers includes a first identifier identifying the first cell or frequency (18-1);
transmitting, for each of one or more neighbor identifiers that respectively identify one or more neighbor cells or frequencies, satellite assistance information associated with that neighbor cell or frequency;
wherein the indication (25) is that the first identifier does not match any neighbor identifier for which the network node has transmitted satellite assistance information.
   B7. The method of embodiment B6, wherein transmitting, for each of one or more neighbor identifiers that respectively identify one or more neighbor cells or frequencies, satellite assistance information associated with that neighbor cell or frequency comprises transmitting a list of one or more neighbor cell configurations, wherein each neighbor cell configuration in the list includes a neighbor identifier that identifies a neighbor cell or frequency and also includes satellite assistance information associated with the neighbor cell or frequency.
   B8. The method of any of embodiments B6-B7, wherein the satellite assistance information is transmitted in System Information.
   B9. The method of any of embodiments B6-B8, wherein the satellite assistance information is transmitted in System Information Block #19, SIB19, or a System Information Block #31, SIB31.
   B10. The method of any of embodiments B6-B9, wherein the list of one or more identifiers identifying one or more cells or frequencies on which the communication device is to perform a measurement is included in a cellsToAddModList field or an allowedCellsToAddModList field.
   B11. The method of any of embodiments B1-B5, wherein the second cell or frequency (18-2) is a serving cell or frequency, wherein the first cell or frequency (18-1) is a neighbor cell or frequency, wherein the indication (25) indicates that the neighbor cell or frequency is associated with the same satellite or satellite assistance information as that of the serving cell or frequency, wherein the method further comprises transmitting a neighbor cell configuration information element for the neighbor cell or frequency, wherein the neighbor cell configuration information element includes a neighbor identifier identifying the neighbor cell or frequency but excludes satellite assistance information, wherein the indication (25) is that the neighbor cell configuration information element excludes satellite assistance information.
   B12. The method of embodiment B11, wherein the neighbor cell configuration information element is an NTN-NeighCellConfig-r17 information element, wherein the NTN-NeighCellConfig-r17 information element includes physCellId-r17 identifying the serving cell or includes carrierFreq-r17 identifying the serving frequency but excludes ntn-Config-r17 as the satellite assistance information.
   B13. The method of any of embodiments B1-B5, wherein the method further comprises transmitting a list of one or more identifiers identifying one or more cells or frequencies, including the first cell or frequency (18-1), that are each associated with the same satellite or satellite assistance information as that with which the second cell or frequency (18-2) is associated, wherein the indication (25) is the identifier of the first cell or frequency (18-1) being included in the list.
   B14. The method of embodiment B13, wherein the list of one or more identifiers is included in a measurement configuration (26) or a measurement object information element.
   B15. The method of embodiment B13, wherein the list of one or more identifiers is included in System Information.
   B16. The method of embodiment B13, wherein the list of one or more identifiers is included in System Information Block #19, SIB19, or a System Information Block #31, SIB31.
   B17. The method of embodiment B13, wherein the list of one or more identifiers is included in an information element that includes serving satellite information or neighbor cell information.
   B18. The method of any of embodiments B1-B5, wherein the indication (25) is a flag associated with an identifier of the first cell or frequency (18-1) indicating that the first cell or frequency (18-1) is associated with the same satellite or satellite assistance information as that with which the second cell or frequency (18-2) is associated.
   B19. The method of embodiment B18, wherein the second cell or frequency (18-2) is a serving cell of the communication device or a carrier frequency of the serving cell, wherein the method further comprises transmitting a list of one or more identifiers identifying one or more cells or frequencies, including the first cell or frequency (18-1), wherein each of at least one of the one or more identifiers in the list is associated with a respective flag indicating whether or not the cell or frequency identified by the identifier is associated with the same satellite or satellite assistance information as that with which the second cell or frequency (18-2) is associated.
   B20. The method of any of embodiments B1-B5, further comprising transmitting a message that includes satellite assistance information for a serving cell or frequency and that further includes satellite assistance information for each of one or more neighbor cells or frequencies, wherein the indication (25) is a pointer associated with the first cell or frequency (18-1) pointing to satellite assistance information in the message that is associated with the first cell or frequency (18-1).
   B21. The method of embodiment B20, wherein each of the satellite assistance information for the serving cell or frequency and the satellite assistance information for each of the one or more neighbor cells or frequencies is mapped to a numeric value, wherein the pointer is the numeric value that is mapped to the satellite assistance information in the message that is associated with the first cell or frequency (18-1).
   B22. The method of embodiment B21, wherein each of the satellite assistance information for the serving cell or frequency and the satellite assistance information for each of the one or more neighbor cells or frequencies is mapped to a numeric value that corresponds to an ordering of the satellite assistance information in the message.
   B23. The method of any of embodiments B20-B22, wherein the message is a System Information message.
   B24. The method of any of embodiments B20-B23, wherein the message is or conveys a System Information Block #19, SIB19, or a System Information Block #31, SIB31.
   B25. The method of any of embodiments B20-B24, wherein the indication (25) is transmitted in a measurement configuration (26) or a measurement object.
   B26. The method of any of embodiments B20-B25, wherein the pointer is specific to the first cell or frequency (18-1).
   B27. The method of any of embodiments B20-B25, wherein the pointer is common to multiple cells or frequencies such that the pointer points to satellite assistance information in the message that is associated with each of the multiple cells or frequencies.
   B28. The method of any of embodiments B1-B27, wherein the second cell or frequency (18-2) is a serving cell of the communication device or a carrier frequency of the serving cell, and wherein the first cell or frequency (18-1) is a neighbor cell or a carrier frequency of the neighbor cell.
   B29. The method of any of embodiments B1-B5, further comprising transmitting signaling that explicitly includes satellite assistance information for one or more cells or frequencies, including the second cell or frequency (18-2), wherein the indication (25) is that the signaling does not explicitly include satellite assistance information for the first cell or frequency (18-1).
   B30. The method of any of embodiments B1-B29, wherein the communication device is configured to assume that the first cell or frequency (18-1) is, or is not, associated with the same satellite or satellite assistance information as that with which the second cell or frequency (18-2) is associated in accordance with the indication (25).
   B31. The method of any of embodiments B1-B29, wherein the indication (25) indicates that the first cell or frequency (18-1) is associated with the same satellite or satellite assistance information as that with which the second cell or frequency (18-2) is associated.
   B32. The method of embodiment B31, further comprising, based on the indication (25), receiving a report of results of a measurement performed on the first cell or frequency (18-1) using satellite assistance information associated with the second cell or frequency (18-2).
   B33. The method of any of embodiments B1-B29, wherein the indication (25) indicates that the first cell or frequency (18-1) is not associated with the same satellite or satellite assistance information as that with which the second cell or frequency (18-2) is associated.

### B34. Reserved

B35. The method of embodiment B1, further comprising transmitting a list of one or more identifiers identifying one or more cells or frequencies that are each not associated with the same satellite or satellite assistance information as that with which the second cell or frequency (18-2) is associated, wherein the indication (25) that the first cell or frequency (18-1) is not associated with the same satellite or satellite assistance information as that with which the second cell or frequency (18-2) is associated is the identifier identifying the first cell or frequency (18-1) being included in the list.
B36. The method of embodiment B35, wherein the list is transmitted in a measurement configuration (26) or a measurement object.
B37. The method of any of embodiments B35-B36, wherein the list is or is conveyed by an excludedCellsToAddModList.
B38. The method of any of embodiments B1-B37, wherein satellite assistance information associated with a cell or frequency includes one or more parameters for the communication device to access the cell or frequency via a satellite.
B39. The method of any of embodiments B1-B38, wherein satellite assistance information associated with a cell or frequency includes satellite ephemeris information, epoch timing information, modified scheduling information, and/or timing advance information to assist the communication device to access the cell or frequency via a satellite.
B40. The method of any of embodiments B1-B39, wherein the communication network is a non-terrestrial network.
B41. The method of any of embodiments B1-B40, wherein the indication (25) indicates that the same satellite provides both the first cell or frequency (18-1) and the second cell or frequency (18-2).
BB1. A method performed by a network node configured for use in a communication network, the method comprising:
transmitting, to a communication device, an indication (25) that a satellite (12) or satellite assistance information (24-1) for a first cell or frequency (18-1) is the same as that (12, 24-1) for a second cell or frequency (18-2).
   BB2. The method of embodiment BB1, wherein the second cell or frequency (18-2) is a serving cell of the communication device or a carrier frequency of the serving cell.
   BB3. The method of any of embodiments BB1-BB2, wherein the first cell or frequency (18-1) is a measurement object that is an object of a measurement to be performed by the communication device.
   BB4. The method of any of embodiments BB1-BB3, wherein the indication (25) is included in a measurement configuration (26) that specifies a measurement to be performed by the communication device on the first cell or frequency (18-1).
   BB5. The method of any of embodiments BB1-BB4, wherein the indication (25) is included in a measurement object information element that includes information about the first cell or frequency (18-1) on which the communication device is to perform a measurement.
   BB6. The method of any of embodiments BB1-BB5, wherein the second cell or frequency (18-2) is a serving cell of the communication device or a carrier frequency of the serving cell, wherein the indication (25) indicates that the satellite or satellite assistance information associated with the first cell or frequency (18-1) is the same as that with which the second cell or frequency (18-2) is associated, wherein the method further comprises:
transmitting a list of one or more identifiers identifying one or more cells or frequencies on which the communication device is to perform a measurement, wherein the list of one or more identifiers includes a first identifier identifying the first cell or frequency (18-1);
transmitting, for each of one or more neighbor identifiers that respectively identify one or more neighbor cells or frequencies, satellite assistance information associated with that neighbor cell or frequency;
wherein the indication (25) is that the first identifier does not match any neighbor identifier for which the network node has transmitted satellite assistance information.
   BB7. The method of embodiment BB6, wherein transmitting, for each of one or more neighbor identifiers that respectively identify one or more neighbor cells or frequencies, satellite assistance information associated with that neighbor cell or frequency comprises transmitting a list of one or more neighbor cell configurations, wherein each neighbor cell configuration in the list includes a neighbor identifier that identifies a neighbor cell or frequency and also includes satellite assistance information associated with the neighbor cell or frequency.
   BB8. The method of any of embodiments BB6-BB7, wherein the satellite assistance information is transmitted in System Information.
   BB9. The method of any of embodiments BB6-BB8, wherein the satellite assistance information is transmitted in System Information Block #19, SIB19, or a System Information Block #31, SIB31.
   BB10. The method of any of embodiments BB6-BB9, wherein the list of one or more identifiers identifying one or more cells or frequencies on which the communication device is to perform a measurement is included in a cellsToAddModList field or an allowedCellsToAddModList field.
   BB11. The method of any of embodiments BB1-BB5, wherein the second cell or frequency (18-2) is a serving cell or frequency, wherein the first cell or frequency (18-1) is a neighbor cell or frequency, wherein the indication (25) indicates that the satellite or satellite assistance information associated with the neighbor cell or frequency is the same as that associated with the serving cell or frequency, wherein the method further comprises transmitting a neighbor cell configuration information element for the neighbor cell or frequency, wherein the neighbor cell configuration information element includes a neighbor identifier identifying the neighbor cell or frequency but excludes satellite assistance information, wherein the indication (25) is that the neighbor cell configuration information element excludes satellite assistance information.
   BB12. The method of embodiment BB11, wherein the neighbor cell configuration information element is an NTN-NeighCellConfig-r17 information element, wherein the NTN-NeighCellConfig-r17 information element includes physCellId-r17 identifying the serving cell or includes carrierFreq-r17 identifying the serving frequency but excludes ntn-Config-r17 as the satellite assistance information.
   BB13. The method of any of embodiments BB1-BB5, wherein the method further comprises transmitting a list of one or more identifiers identifying one or more cells or frequencies, including the first cell or frequency (18-1), that are each associated with the same satellite or satellite assistance information as that with which the second cell or frequency (18-2) is associated, wherein the indication (25) is the identifier of the first cell or frequency (18-1) being included in the list.
   BB14. The method of embodiment BB13, wherein the list of one or more identifiers is included in a measurement configuration (26) or a measurement object information element.
   BB15. The method of embodiment BB13, wherein the list of one or more identifiers is included in System Information.
   BB16. The method of embodiment BB13, wherein the list of one or more identifiers is included in System Information Block #19, SIB19, or a System Information Block #31, SIB31.
   BB17. The method of embodiment BB13, wherein the list of one or more identifiers is included in an information element that includes serving satellite information or neighbor cell information.
   BB18. The method of any of embodiments BB1-BB5, wherein the indication (25) is a flag associated with an identifier of the first cell or frequency (18-1) indicating that the satellite or satellite assistance information associated with the first cell or frequency (18-1) is the same as that with which the second cell or frequency (18-2) is associated.
   BB19. The method of embodiment BB18, wherein the second cell or frequency (18-2) is a serving cell of the communication device or a carrier frequency of the serving cell, wherein the method further comprises transmitting a list of one or more identifiers identifying one or more cells or frequencies, including the first cell or frequency (18-1), wherein each of at least one of the one or more identifiers in the list is associated with a respective flag indicating whether or not the satellite or satellite assistance information associated with the cell or frequency identified by the identifier is the same as that with which the second cell or frequency (18-2) is associated.
   BB20. The method of any of embodiments BB1-BB5, further comprising transmitting a message that includes satellite assistance information for a serving cell or frequency and that further includes satellite assistance information for each of one or more neighbor cells or frequencies, wherein the indication (25) is a pointer associated with the first cell or frequency (18-1) pointing to satellite assistance information in the message that is associated with the first cell or frequency (18-1).
   BB21. The method of embodiment BB20, wherein each of the satellite assistance information for the serving cell or frequency and the satellite assistance information for each of the one or more neighbor cells or frequencies is mapped to a numeric value, wherein the pointer is the numeric value that is mapped to the satellite assistance information in the message that is associated with the first cell or frequency (18-1).
   BB22. The method of embodiment BB21, wherein each of the satellite assistance information for the serving cell or frequency and the satellite assistance information for each of the one or more neighbor cells or frequencies is mapped to a numeric value that corresponds to an ordering of the satellite assistance information in the message.
   BB23. The method of any of embodiments BB20-BB22, wherein the message is a System Information message.
   BB24. The method of any of embodiments BB20-BB23, wherein the message is or conveys a System Information Block #19, SIB19, or a System Information Block #31, SIB31.
   BB25. The method of any of embodiments BB20-BB24, wherein the indication (25) is transmitted in a measurement configuration (26) or a measurement object.
   BB26. The method of any of embodiments BB20-BB25, wherein the pointer is specific to the first cell or frequency (18-1).
   BB27. The method of any of embodiments BB20-BB25, wherein the pointer is common to multiple cells or frequencies such that the pointer points to satellite assistance information in the message that is associated with each of the multiple cells or frequencies.
   BB28. The method of any of embodiments BB1-BB27, wherein the second cell or frequency (18-2) is a serving cell of the communication device or a carrier frequency of the serving cell, and wherein the first cell or frequency (18-1) is a neighbor cell or a carrier frequency of the neighbor cell.
   BB29. The method of any of embodiments BB1-BB5, further comprising transmitting signaling that explicitly includes satellite assistance information for one or more cells or frequencies, including the second cell or frequency (18-2), wherein the indication (25) is that the signaling does not explicitly include satellite assistance information for the first cell or frequency (18-1).
   BB30. The method of any of embodiments BB1-BB29, wherein the communication device is configured to assume that the satellite or satellite assistance information associated with the first cell or frequency (18-1) is, or is not, the same as that with which the second cell or frequency (18-2) is associated in accordance with the indication (25).
   BB31. The method of any of embodiments BB1-BB29, wherein the indication (25) indicates that the satellite or satellite assistance information associated with the first cell or frequency (18-1) is the same as that associated with the second cell or frequency (18-2).
   BB32. The method of embodiment BB31, wherein the communication device is configured to, based on the indication (25), perform a measurement on the first cell or frequency (18-1) using satellite assistance information associated with the second cell or frequency (18-2).
   BB33. The method of any of embodiments BB1-A2AA9, wherein the indication (25) indicates that the satellite or satellite assistance information associated with the first cell or frequency (18-1) is not the same as that associated with the second cell or frequency (18-2).

### BB34. Reserved.

BB35. The method of embodiment BB1, further comprising transmitting a list of one or more identifiers identifying one or more cells or frequencies that are each not associated with the same satellite or satellite assistance information as that with which the second cell or frequency (18-2) is associated, wherein the indication (25) that the satellite or satellite assistance information associated with the first cell or frequency (18-1) is not the same as that associated with the second cell or frequency (18-2) is the identifier identifying the first cell or frequency (18-1) being included in the list.
BB36. The method of embodiment BB35, wherein the list is transmitted in a measurement configuration (26) or a measurement object.
BB37. The method of any of embodiments BB35-BB36, wherein the list is or is conveyed by an excludedCells ToAddModList.
BB38. The method of any of embodiments BB1-BB37, wherein satellite assistance information associated with a cell or frequency includes one or more parameters for the communication device to access the cell or frequency via a satellite.
BB39. The method of any of embodiments BB1-BB38, wherein satellite assistance information associated with a cell or frequency includes satellite ephemeris information, epoch timing information, modified scheduling information, and/or timing advance information to assist the communication device to access the cell or frequency via a satellite.
BB40. The method of any of embodiments BB1-BB39, wherein the communication network is a non-terrestrial network.
BB41. The method of any of embodiments BB1-BB40, wherein the indication (25) indicates that the same satellite provides both the first cell or frequency (18-1) and the second cell or frequency (18-2).
BB. The method of any of the previous embodiments, further comprising:
obtaining user data; and
forwarding the user data to a host computer or a communication device.

### Group C Embodiments

C1. A communication device configured to perform the method of any of the Group A embodiments.
C2. A communication device comprising processing circuitry configured to perform the method of any of the Group A embodiments.
C3. A communication device comprising:
communication circuitry; and
processing circuitry configured to perform the method of any of the Group A embodiments.
   C4. A communication device comprising:
processing circuitry configured to perform the method of any of the Group A embodiments; and
power supply circuitry configured to supply power to the communication device.
   C5. A communication device comprising:
processing circuitry and memory, the memory containing instructions executable by the processing circuitry whereby the communication device is configured to perform the method of any of the Group A embodiments.
   C6. The communication device of any of embodiments C1-C5, wherein the communication device is a wireless communication device.
   C7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform the method of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C8. A computer program comprising instructions which, when executed by at least one processor of a communication device, causes the communication device to perform the method of any of the Group A embodiments.
   C9. A carrier containing the computer program of embodiment C7, wherein the carrier is one of an electronic signal, optical signal, radio signal, or computer readable storage medium.
   C10. A network node configured to perform the method of any of the Group B embodiments.
   C11. A network node comprising processing circuitry configured to perform the method of any of the Group B embodiments.
   C12. A network node comprising:
communication circuitry; and
processing circuitry configured to perform the method of any of the Group B embodiments.
   C13. A network node comprising:
processing circuitry configured to perform the method of any of the Group B embodiments;
power supply circuitry configured to supply power to the network node.
   C14. A network node comprising:
processing circuitry and memory, the memory containing instructions executable by the processing circuitry whereby the network node is configured to perform the method of any of the Group B embodiments.
   C15. The network node of any of embodiments C10-C14, wherein the network node is a base station.
   C16. A computer program comprising instructions which, when executed by at least one processor of a network node, causes the network node to perform the method of any of the Group B embodiments.
   C17. The computer program of embodiment C16, wherein the network node is a base station.
   C18. A carrier containing the computer program of any of embodiments C16-C17, wherein the carrier is one of an electronic signal, optical signal, radio signal, or computer readable storage medium.

### Group D Embodiments

D1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the method of any of the Group B embodiments to transmit the user data from the host to the UE.
   D2. The host of the previous embodiment, wherein:
the processing circuitry of the host is configured to execute a host application that provides the user data; and
the UE comprises processing circuitry configured to execute a client application associated with the host application to receive the transmission of user data from the host.
   D3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the method of any of the Group B embodiments to transmit the user data from the host to the UE.
   D4. The method of the previous embodiment, further comprising, at the network node, transmitting the user data provided by the host for the UE.
   D5. The method of any of the previous 2 embodiments, wherein the user data is provided at the host by executing a host application that interacts with a client application executing on the UE, the client application being associated with the host application.
   D6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the method of any of the Group B embodiments to transmit the user data from the host to the UE.
   D7. The communication system of the previous embodiment, further comprising:
the network node; and/or
the user equipment.
   D8. The communication system of the previous 2 embodiments, wherein:
the processing circuitry of the host is configured to execute a host application, thereby providing the user data; and
the host application is configured to interact with a client application executing on the UE, the client application being associated with the host application.
   D9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform method of any of the Group B embodiments to receive the user data from the UE for the host.
   D10. The host of the previous 2 embodiments, wherein:
the processing circuitry of the host is configured to execute a host application, thereby providing the user data; and
the host application is configured to interact with a client application executing on the UE, the client application being associated with the host application.
   D11. The host of the any of the previous 2 embodiments, wherein the initiating receipt of the user data comprises requesting the user data.
   D12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the method of any of the Group B embodiments to receive the user data from the UE for the host.
   D13. The method of the previous embodiment, further comprising at the network node, transmitting the received user data to the host.
   D14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the method of any of the Group A embodiments to receive the user data from the host.
   D15. The host of the previous embodiment, wherein the cellular network further includes a network node configured to communicate with the UE to transmit the user data to the UE from the host.
   D16. The host of the previous 2 embodiments, wherein:
the processing circuitry of the host is configured to execute a host application, thereby providing the user data; and
the host application is configured to interact with a client application executing on the UE, the client application being associated with the host application.
   D17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the method of any of the Group A embodiments to receive the user data from the host.
   D18. The method of the previous embodiment, further comprising:
at the host, executing a host application associated with a client application executing on the UE to receive the user data from the UE.
   D19. The method of the previous embodiment, further comprising:
at the host, transmitting input data to the client application executing on the UE, the input data being provided by executing the host application,
wherein the user data is provided by the client application in response to the input data from the host application.
   D20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the method of any of the Group A embodiments to transmit the user data to the host.
   D21. The host of the previous embodiment, wherein the cellular network further includes a network node configured to communicate with the UE to transmit the user data from the UE to the host.
   D22. The host of the previous 2 embodiments, wherein:
the processing circuitry of the host is configured to execute a host application, thereby providing the user data; and
the host application is configured to interact with a client application executing on the UE, the client application being associated with the host application.
   D23. A method implemented by a host configured to operate in a communication system that further includes a network node and a user equipment (UE), the method comprising:
at the host, receiving user data transmitted to the host via the network node by the UE, wherein the UE performs the method of any of the Group A embodiments to transmit the user data to the host.
   D24. The method of the previous embodiment, further comprising:
at the host, executing a host application associated with a client application executing on the UE to receive the user data from the UE.
   D25. The method of the previous embodiments, further comprising:
at the host, transmitting input data to the client application executing on the UE, the input data being provided by executing the host application,
wherein the user data is provided by the client application in response to the input data from the host application.

1.-38. (canceled)

39. A method performed by a communication device, the method comprising:
receiving an indication that a satellite or satellite assistance information for a first cell or frequency is the same as that for a second cell or frequency;
wherein the indication is included in a measurement configuration that specifies a measurement to be performed by the communication device on the first cell or frequency; and
wherein the indication indicates that the first cell or frequency is associated with the same satellite or satellite assistance information as that being associated with the second cell or frequency.

40. The method of claim 39, further comprising:
receiving satellite assistance information for the second cell or frequency; and
based on the indication, performing a measurement on the first cell or frequency using the satellite assistance information received for the second cell or frequency.

41. The method of claim 39, wherein the second cell or frequency is a serving cell of the communication device or a carrier frequency of the serving cell.

42. The method of claim 39, wherein the indication is a flag associated with an identifier of the first cell or frequency indicating that the satellite or satellite assistance information associated with the first cell or frequency is the same as that with which the second cell or frequency is associated.

43. The method of claim 39, further comprising receiving a message that includes satellite assistance information for a serving cell or frequency and that further includes satellite assistance information for each of one or more neighbor cells or frequencies, wherein the indication is a pointer associated with the first cell or frequency pointing to satellite assistance information in the message that is associated with the first cell or frequency.

44. The method of claim 39, wherein the second cell or frequency is a serving cell of the communication device or a carrier frequency of the serving cell, and wherein the first cell or frequency is a neighbor cell or a carrier frequency of the neighbor cell.

45. The method of claim 39, wherein the indication indicates that the satellite or satellite assistance information associated with the first cell or frequency is the same as that associated with the second cell or frequency, and wherein the method further comprises, based on the indication, performing a measurement on the first cell or frequency using satellite assistance information associated with the second cell or frequency.

46. The method of claim 39, wherein satellite assistance information associated with a cell or frequency includes satellite ephemeris information, epoch timing information, modified scheduling information, and/or timing advance information to assist the communication device to access the cell or frequency via a satellite.

47. The method of claim 39, wherein the indication indicates that the same satellite provides both the first cell or frequency and the second cell or frequency.

48. A method performed by a network node configured for use in a communication network, the method comprising:
transmitting, to a communication device, an indication that a satellite or satellite assistance information for a first cell or frequency is the same as that for a second cell or frequency.

49. The method of claim 48, wherein the second cell or frequency is a serving cell of the communication device or a carrier frequency of the serving cell.

50. The method of claim 49, wherein the first cell or frequency is a measurement object that is an object of a measurement to be performed by the communication device, and wherein the indication is included in a measurement configuration that specifies a measurement to be performed by the communication device on the first cell or frequency.

51. The method of claim 48, wherein the method further comprises transmitting a list of one or more identifiers identifying one or more cells or frequencies, including the first cell or frequency, that are each associated with the same satellite or satellite assistance information as that with which the second cell or frequency is associated, wherein the indication comprises the identifier of the first cell or frequency being included in the list.

52. The method of claim 48, wherein the indication is a flag associated with an identifier of the first cell or frequency indicating that the satellite or satellite assistance information associated with the first cell or frequency is the same as that with which the second cell or frequency is associated.

53. The method of claim 48, further comprising receiving a message that includes satellite assistance information for a serving cell or frequency and that further includes satellite assistance information for each of one or more neighbor cells or frequencies, wherein the indication is a pointer associated with the first cell or frequency pointing to satellite assistance information in the message that is associated with the first cell or frequency.

54. The method of claim 48, wherein the second cell or frequency is a serving cell of the communication device or a carrier frequency of the serving cell, and wherein the first cell or frequency is a neighbor cell or a carrier frequency of the neighbor cell.

55. The method of claim 48, wherein the indication indicates that the satellite or satellite assistance information associated with the first cell or frequency is the same as that associated with the second cell or frequency.

56. The method of claim 48, wherein satellite assistance information associated with a cell or frequency includes satellite ephemeris information, epoch timing information, modified scheduling information, and/or timing advance information to assist the communication device to access the cell or frequency via a satellite.

57. The method of claim 48, wherein the indication indicates that the same satellite provides both the first cell or frequency and the second cell or frequency.

58. A communication device comprising:
communication circuitry; and
processing circuitry configured to receive an indication that a satellite or satellite assistance information for a first cell or frequency is the same as that for a second cell or frequency;
wherein the indication is included in a measurement configuration that specifies a measurement to be performed by the communication device on the first cell or frequency; and
wherein the indication is indicative of that the first cell or frequency is associated with the same satellite or satellite assistance information as that being associated with the second cell or frequency.

59. A network node configured for use in a communication network, the network node comprising:
communication circuitry; and
processing circuitry configured to transmit, to a communication device, an indication that a satellite or satellite assistance information for a first cell or frequency is the same as that for a second cell or frequency.
